(19) United States
(12) Patent Application Publication
(10) Pub. No.: US 2026/0199831 A1
(43) Pub. Date: Jul. 16, 2026

(54) CALCIUM HYDROXIDE COMPOSITION AND CARBON REMOVAL IN AIR USING THE SAME

(71) Applicant: Carmeuse Technologies SA, Louvain-la-Neuve (BE)

(72) Inventors: Johan BRANDT, Louvain-la-Neuve (BE); Nassim BOUCHOUL, Louvain-la-Neuve (BE); Aurélien CHARDON, Louvain-la-Neuve (BE); Pierre-Olivier CAMBIER, Louvain-la-Neuve (BE)

(21) Appl. No.: 19/444,886

(22) Filed: Jan. 9, 2026

(30) Foreign Application Priority Data
Jan. 10, 2025 (EP) 25151142.4

(51) Int. Cl. B01D 53/62; B01D 53/14; B01D 53/96

(52) U.S. Cl. CPC B01D 53/62; B01D 53/1475; B01D 53/1493; B01D 53/965; B01D 2251/404; B01D 2251/604; B01D 2257/504; B01D 2258/06

(57) ABSTRACT

The present disclosure relates to a process for direct capture of carbon dioxide in air, to include: providing a calcium hydroxide-based composition; contacting the composition with air so as to capture CO₂ contained in the air by transforming at least some of the calcium hydroxide of the composition into calcium carbonate, forming a calcium carbonate-based composition; collecting the calcium carbonate-based composition; and extracting at least some CO₂ from at least some of the collected calcium carbonate-based composition, preferably via calcination and/or electrolysis. The calcium hydroxide-based composition includes Ca(OH)₂ and an ionic compound having an alkali earth metal cation, preferably the ionic compound having at least one of a hydroxide, halogen and/or carbonate anion.

### TECHNICAL FIELD

The present disclosure relates to a process for the direct capture of carbon dioxide in air and calcium hydroxide-based compositions.

### BACKGROUND ART

CO₂ emissions linked to human activities are recognized as being responsible for climate change. Although efforts are being made to decrease the quantity of CO₂ released into the atmosphere, there is a growing consensus that decreasing emissions alone will not be sufficient to avoid global temperature increase of more than 1.5° C. compared to pre-industrial era.

There is therefore a need to deploy techniques capable of removing CO₂ from the atmosphere. Such techniques are often designated under the generic term carbon dioxide removal technologies (CDR technologies), which includes for instance afforestation, bio-energy with carbon capture and storage (BECCS) and Direct Air Capture (DAC). These technologies can help in capturing and/or storing up to 10 billion tons of CO₂ per year by 2050 and are thus recognized as essential means to achieve carbon neutrality.

Direct Air Capture refers to CDR approaches that rely on chemicals that react with atmospheric CO₂ and are followed by a subsequent step aimed at separating the chemicals and the CO₂ in a substantially pure form so that it is compatible with sequestration or use.

Several technological routes have been proposed for DAC and some have reached or are close to reaching commercial maturity. However, they come with several techno-economic challenges, such as:
use of large and relatively engineered equipment to ensure efficient contact between the chemicals with strongly diluted atmospheric CO₂;
need for electricity to run fans to blow air and pumps for transporting the chemicals in liquid form;
need for thermal energy to separate the chemicals and the CO₂;
cost and complexity in manufacturing reacting material;
water loss linked to the evaporation of the water from the aqueous solution containing the reacting chemical;
upscaling of the technique to cater high demand of CDR;
minimizing the use of natural resources (such as water, as mentioned above, but also all the other components used in the process);
sensitivity of the DAC process to local weather conditions.

Therefore, there is thus a need for DAC system with reduced capital and operational cost that uses cheap and widely available raw materials to ensure cost efficiency and scalability.

In this regard, quicklime (alternatively hydrated lime) produced from a source of calcium carbonate such as natural limestone, can be used for capturing CO₂ according to the following reaction:

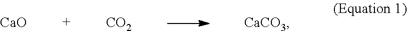

alternatively

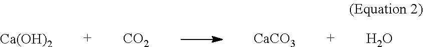

The formed carbonate can then be calcined again to produce time and substantially pure CO₂ for use or sequestration:

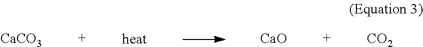

The heat necessary for the calcination can be provided by the combustion of fuel. For instance, industrial oxygen can be advantageously used instead of air in order to avoid dilution of the CO₂ with nitrogen from the air.

After a purification step, both the CO₂ resulting from the decomposition of calcium carbonate and from the combustion of fuel can be sequestered, resulting in net removal of CO₂ from the atmosphere.

The produced lime or hydrated lime can then be re-exposed to atmospheric air for subsequent CO₂ capture.

Hydrated lime Ca(OH)₂ has some advantages compared to quicklime CaO due to its microstructural properties that enable faster and higher conversion of lime to carbonate. Relative humidity has also been identified as key parameter to foster carbonation, since the reaction results from a dissolution-precipitation mechanism. For instance, N. Koga et al. (Ceramics International 41 (2015) 9482-9487) reported that no carbonation reaction occurs at 0% relative humidity. More interestingly, it was highlighted that the conversion rate plateaued at 40% conversion to CaCO₃ when relative humidity was 50%.

The ability of the sorbent to achieve high conversion to carbonate is indeed important to minimize the amount of sorbent required to capture a given quantity of CO₂. Moreover, unreacted calcium hydroxides induce an energy penalty during the calcination step:
The standard enthalpy of calcination of CaCO₃ is 178 kJ/mol.
The standard enthalpy of de-hydration of Ca(OH)2 is 65 kJ/mol. It should be noted that for each mol of de-hydrated Ca(OH)2 1 mol of H2O remains as steam (i.e., latent heat of vaporization is not recovered), therefore increasing the dehydration enthalpy to about 65+2,256 kJ/g*18 g/mol=106 kJ/mol.

### SUMMARY

The present disclosure aims to provide a solution to overcome at least one drawback of the teaching provided by the prior art document.

In particular, the disclosure aims to provide a direct air capture process or sorbents capable of achieving a high conversion ratio, preferably under different types of weather conditions, particularly under arid conditions.

For the above purpose, the present disclosure is directed to a process for direct capture of carbon dioxide in air comprising the following steps:
providing a calcium hydroxide-based composition;
contacting said composition with air so as to capture CO₂ contained in said air by transforming at least some of the calcium hydroxide of said composition into calcium carbonate, forming a calcium carbonate-based composition;
collecting the calcium carbonate-based composition;
extracting at least some CO₂ from at least some of the collected calcium carbonate-based composition, preferably via calcination and/or electrolysis;
   wherein said calcium hydroxide-based composition comprises Ca(OH)₂ and an ionic compound with a content of 0.05% or higher than 0.05% by weight relative to the content of Ca(OH)₂, preferably higher than 0.25% by weight relative to the content of Ca(OH)₂, more preferably higher than 1.0% by weight relative to the content of Ca(OH)₂ but less than 10.0% by weight relative to the content of Ca(OH)₂, preferably less than 7.0% by weight relative to the content of Ca(OH)₂, more preferably less than 5% by weight relative to the content of Ca(OH)₂, in particular less than 2.0% by weight relative to the content of Ca(OH)₂, said ionic compound comprising an alkali metal cation, preferably said ionic compound comprising at least one of a hydroxide, halogen and/or carbonate anion, wherein the calcium hydroxide-based composition has a weight fraction of Ca(OH)₂ of at least 80%, preferably at least 90% on a dry basis.

According to specific embodiments of the present disclosure, the process for direct capture of carbon dioxide in air comprises one or more of the following features/steps:
the ionic compound consists in at least one element selected from the group consisting of NaOH, KOH, NaCl, KCl, Na₂CO₃ and K₂CO₃;
the Ca(OH)₂ of the calcium hydroxide-based composition and/or the ionic compound is homogeneously distributed in said composition;
in the step of contacting said composition with air, the calcium hydroxide-based composition is exposed to air having temperatures lower than 39° C. or equal to 39° C. and optionally the temperatures being greater than 0° C., preferably greater than 15° C.;
in the step of contacting said composition with air, the calcium hydroxide-based composition is exposed to air having relative humidity levels falling in the range from 10% to 95%, preferably in the range from 10% to 80%, more preferably in the range from 30% to 70%, in particular in the range from 35% to 60%;
the collection of the calcium carbonate-based composition takes place when said composition reaches a CO₂ content of at least 31%, preferably at least 33%, more preferably at least 37%, in particular at least 40% by weight on a dry basis;
the step of providing the calcium hydroxide-based composition comprises providing a malleable or flowable composition containing Ca(OH)₂ and the ionic compound, said (malleable or flowable) composition having a water content above 35% by weight of said composition, and optionally at most 85% by weight of said composition, such as a putty lime or a milk of lime;
a) mixing a calcium hydroxide-based powder composition with the ionic compound, water and optionally a first additive or
b) slaking quicklime, possibly partly hydrated, in presence of the ionic compound and optionally in presence of a second additive,
in order to obtain the malleable or flowable composition containing Ca(OH)₂ and the ionic compound, wherein the ionic compound is introduced during at least one of the mixing of step a) and/or slaking of step b);
the supply of the calcium hydroxide-based composition comprises the supply of shaped bodies containing Ca(OH)₂ and the ionic compound or the step of providing of the calcium hydroxide-based composition comprises providing shaped bodies containing Ca(OH)₂ and the ionic compound, preferably said shaped bodies being in the form of pellets, granules, extrudates, 3D printings or compacts such as tablets or briquettes, preferably said shaped bodies having at least one dimension greater than 3 mm;
shaping a malleable or flowable composition containing Ca(OH)₂ and the ionic compound, said (malleable or flowable) composition having a water content above 35% by weight of said composition, and optionally at most 85% by weight of said composition, such as a putty lime or a milk of lime, into the shaped bodies, in particular 3D printings or extrudates, preferably said malleable or flowable composition being obtained by mixing (step a) a calcium hydroxide-based powder composition with water, and optionally a first additive or slaking quicklime (step b), possibly partly hydrated, optionally in presence of a second additive, optionally forming ridges on the shaped bodies, notably curing said shaped bodies with CO₂, wherein the ionic compound is introduced during at least one of said mixing (step a) and/or said slaking (step b);
prior to the shaping of the shaped bodies, mixing the malleable or flowable composition containing Ca(OH)₂ and the ionic compound with at least one element selected from the group comprising structural elements, such as woven or non-woven fibers, at least one additive, water, or any combination thereof, preferably the at least one additive being selected from the group comprising shaping additive, pore-forming agent, compressive strength enhancer such as cementitious material, additives to increase particle size such as gypsum and air entraining agent;
shaping a powder composition containing Ca(OH)₂ and the ionic compound into the shaped bodies, in particular pellets, granules, extrudates, 3D printings or compacts such as tablets or briquettes, preferably forming ridges on the shaped bodies, notably curing said shaped bodies with CO₂;
mixing a calcium hydroxide-based powder composition with the ionic compound and optionally at least one element selected from the group comprising structural elements such as woven or non-woven fibers, at least one additive, water, or any combination thereof, thereby forming the powder composition containing Ca(OH)₂ and the ionic compound, preferably the at least one additive being selected from the group comprising shaping additive, pore-forming agent, compressive strength enhancer such as cementitious material, additives to increase particle size such as gypsum and air entraining agent;
a first phase is formed by Ca(OH)₂ of the calcium hydroxide-based composition and a second phase is formed by the ionic compound, wherein the first and second phases are intimately bound and/or homogeneously distributed in the core or throughout the volume of at least one, in particular each one, of the shaped bodies;
the supply of the calcium hydroxide-based composition comprises the supply of a powder composition containing Ca(OH)₂ and the ionic compound or the step of providing of the calcium hydroxide-based composition comprises providing a powder composition containing Ca(OH)₂ and the ionic compound, said composition having a water content lower than or equal to 35% by weight of said composition, preferably at most 20% by weight, more preferably at most 15% by weight of said composition, and optionally at least 5% by weight, preferably at least 10% by weight of said composition, preferably the powder composition containing Ca(OH)₂ and the ionic compound being obtained by mixing a calcium hydroxide-based powder composition with the ionic compound;
   providing a support for the calcium hydroxide-based composition, said support being stationary or in motion relative to a reference frame, and
   contacting the calcium hydroxide-based composition with air in particular in a packed bed such as a fixed bed or a moving bed or in a fluidized bed such as a bubbling bed, a spouted bed, a circulating fluidized bed or an entrained bed, in particular the support being selected from the group comprising trommel, plate, such as corrugated plate, bucket, pile, shelf, tray, filter media, cartridge, grate, tile, wall, brick, carbonated product, net, ground, basket and gabion;
   providing a support for the calcium hydroxide-based composition, said support being stationary or in motion relative to a reference frame, and
   applying, in particular spreading, said composition on the support to form a layer, in particular forming ridges on said layer, preferably said support being selected from the group comprising trommel, plate, such as corrugated plate, bucket, pile, shelf, tray, filter media, such as clothes or bags in a bag filter, cartridge, grate, tile, wall, brick, carbonated product ground and net, preferably further comprising flowing air through the filter media comprising the calcium hydroxide-based composition;
   providing a support for the calcium hydroxide-based composition, said support being stationary or in motion relative to a reference frame, and
   applying, preferably spreading or coating, the calcium hydroxide-based composition on the support to form a layer, in particular forming ridges on said layer, in particular said support being selected from the group comprising plate, such as corrugated plate, bucket, pile, shelf, tray, filter media, such as clothes or bags in a bag filter, cartridge, grate, tile, wall, brick, bead (30) carbonated product, ground and net,
the step of contacting the calcium hydroxide-based composition with said air further comprises adjusting at least one of:
   an air flow rate,
   a calcium hydroxide-based composition flow rate,
   a calcium hydroxide-based composition residence time,
   a calcium hydroxide-based composition inventory,
   an air temperature,
   an air relative humidity,
   an air absolute humidity, and/or
   an absolute water content inside the calcium hydroxide-based composition,
with at least one control means for controlling the CO₂ capture in air comprising at least one of:
   one or more air flow control elements, such as valve, guiding blade, fan, or blower,
   calcium hydroxide-based composition flow control elements
   a humidifier,
   cooler, and/or
   heater,
preferably further providing an air flow inlet arranged upstream from the calcium hydroxide-based composition and/or an air flow outlet arranged downstream from the calcium hydroxide-based composition, in particular the step of adjusting further comprising adjusting as a function of at least one of:
   weather conditions, in particular an ambient air temperature and/or an air relative humidity as measured or estimated at the air flow inlet,
   the CO₂ content in said composition at one or more locations, and/or
   the difference in CO₂ concentration between the air flow inlet and outlet;
conditioning the collected calcium carbonate-based composition prior to the step of extracting at least some CO₂ from at least some of the collected calcium carbonate-based composition, preferably the step of conditioning comprising at least one of drying, grinding, milling, classifying, dehydroxylating or purifying the collected calcium carbonate-based composition, or any combination thereof, in particular the step of purifying comprising separating at least some of the unreacted calcium hydroxide from the collected calcium carbonate-based composition, for instance via at least one of the following purification processes: air classification, leaching, pealing or floatation, or any combination thereof;
the calcium hydroxide-based powder composition has a specific surface BET lower than 20 m²/g, preferably lower than 15 m²/g, in particular lower than 10 m²/g and/or a porous volume lower than 0.12 cm³/g, in particular lower than 0.1 cm³/g, said partial pore volume being calculated according to the BJH method for a range of pores having a diameter between 20 and 1000 Å in accordance with standard DIN 66134 (February 1998 version);
the calcium hydroxide-based powder composition has a specific surface BET equal or higher than 20 m²/g, preferably higher than 30 m²/g, in particular higher than 35 m²/g and/or a porous volume equal to or higher than 0.12 cm³/g, in particular higher than 0.16 cm³/g, in particular higher than 0.2 cm³/g, said partial pore volume being calculated according to the BJH method for a range of pores having a diameter between 20 and 1000 Å in accordance with standard DIN 66134 (February 1998 version).

The present disclosure can also be related to a calcium hydroxide-based composition comprising Ca(OH)₂ and an ionic compound with a content of 0.05% or higher than 0.05% by weight relative to the content of Ca(OH)₂, preferably higher than 0.25% by weight relative to the content of Ca(OH)₂, more preferably higher than 1.0% by weight relative to the content of Ca(OH)₂ but less than 10.0% by weight relative to the content of Ca(OH)₂, preferably less than 7.0% by weight relative to the content of Ca(OH)₂, more preferably less than 5.0% by weight relative to the content of Ca(OH)₂, in particular less than 2.0% by weight relative to the content of Ca(OH)₂, said ionic compound comprising an alkali and/or alkali earth metal cation and optionally said ionic compound being different from any element of the group consisting of Ca(OH)₂, CaCO₃, Mg(OH)₂ and MgCO₃, preferably said ionic compound comprising at least one of a hydroxide and/or carbonate anion; wherein said calcium hydroxide-based composition has a water content above 35% by weight of said composition, and optionally at most 85% by weight of said calcium hydroxide-based composition.

According to specific embodiments of the present disclosure, the calcium hydroxide-based composition comprises one or more of the following features:
the ionic compound consists in at least one element selected from the group consisting of NaOH, KOH, Na2CO3 and K2CO3;
the calcium hydroxide-based composition is a flowable or malleable composition;
the calcium hydroxide-based composition is a milk of lime or putty lime;
a weight fraction of Ca(OH)2 of at least 80%, preferably at least 90% on a dry basis;
the Ca(OH)2 of the calcium hydroxide-based composition and/or the ionic compound is homogeneously distributed in said composition.

The present disclosure can also be related to a calcium hydroxide-based composition comprising Ca(OH)₂ and an ionic compound with a content of 0.05% or higher than 0.05% by weight relative to the content of Ca(OH)₂, preferably higher than 0.25% by weight relative to the content of Ca(OH)₂, more preferably higher than 1.0% by weight relative to the content of Ca(OH)₂ but less than 10.0% by weight relative to the content of Ca(OH)₂, preferably less than 7.0% by weight relative to the content of Ca(OH)₂, more preferably less than 5.0% by weight relative to the content of Ca(OH)₂, in particular less than 2.0% by weight relative to the content of Ca(OH)₂, said ionic compound comprising an alkali and/or alkali earth metal cation and optionally said ionic compound being different from any element of the group consisting of Ca(OH)₂, CaCO₃, Mg(OH)₂ and MgCO₃, preferably said ionic compound comprising at least one of an halogen anion such as Cl⁻ and/or optionally carbonate anion and optionally an hydroxide anion; wherein said calcium hydroxide-based composition is in the form of shaped bodies (4), wherein the shaped bodies are selected from the group comprising pellets, granules, extrudates, 3D printings or compacts such as tablets or briquettes.

According to specific embodiments of the present disclosure, the calcium hydroxide-based composition comprises one or more of the following features:
the ionic compound comprises or consists in at least one element selected from the group consisting of KCl, NaCl;
an apparent density lower than 1.4 g/cm³, preferably lower than 1.1 g/cm³, and optionally higher than 0.8 g/cm³;
the shaped bodies have at least one dimension greater than 3 mm;
a water content lower than or equal to 35% by weight of said composition, preferably at most 20% by weight, more preferably at most 15% by weight of said composition, and optionally at least 5% by weight, preferably at least 10% by weight of said composition;
a weight fraction of Ca(OH)₂ of at least 80%, preferably at least 90% on a dry basis;
the Ca(OH)₂ of the calcium hydroxide-based composition and/or the ionic compound are homogeneously distributed in said composition.

### BRIEF DESCRIPTION OF THE DRAWINGS

Aspects of the present disclosure will now be described in more detail with reference to the appended drawings, wherein same reference numerals illustrate the same features.

FIG. 1 shows a direct air capture process using baskets filled with sorbent-shaped bodies, disposed on a shelf according to an embodiment of the present disclosure.

FIG. 2 shows a direct air capture process using beads coated with sorbents according to another embodiment of the present disclosure.

FIG. 3 shows a direct air capture process using gabions filled with sorbent-shaped bodies.

FIG. 4 shows a direct air capture process where sorbent is injected in an air flow and collected and contacted with the air for a certain time by using a filter media according to an embodiment of the present disclosure.

FIG. 5 shows a direct air capture process using two rows of gabions filled with sorbent-shaped bodies, arranged in multiple layers, said rows being integrated into an air conditioning structure according to another embodiment of the present disclosure.

FIG. 6 shows a direct air capture process using baskets filled with sorbent-shaped bodies, disposed on shelves integrated into an air conditioning structure according to another embodiment of the disclosure.

FIG. 7 shows a direct air capture process using gabions filled with sorbent-shaped bodies integrated in an air conditioning structure, including a humidifier according to another embodiment of the disclosure.

FIG. 8 discloses a comparison of molar conversions of different sorbents constituted of calcium hydroxide powders with two levels of porosity, either unadditivated or additivated with various ionic compounds according to the present disclosure, tested under four different simulated climatic conditions, namely Test A (CO₂: 2000 ppmv, 10° C. and 75% RH), Test B (CO₂: 2000 ppmv, 30° C. and 75% RH), Test C (CO₂: 2000 ppmv, 10° C. and 45% RH) and Test D (CO₂: 2000 ppmv, 30° C. and 45% RH).

FIGS. 9A and 9B illustrate CO₂ capture measurements over time obtained with the different sorbents under the Test D conditions (CO₂: 2000 ppmv, 30° C. and 45% RH).

FIGS. 10A and 10B illustrate CO₂ capture measurements over time obtained with the different sorbents under the Test B conditions (CO₂: 2000 ppmv, 30° C. and 75% RH).

FIGS. 11A and 11B illustrate CO₂ capture measurements over time obtained with the different sorbents under the Test A conditions (CO₂: 2000 ppmv, 10° C. and 75% RH).

FIGS. 12A and 12B illustrate CO₂ capture measurements over time obtained with the different sorbents under the Test C conditions (CO₂: 2000 ppmv, 10° C. and 45% RH).

FIGS. 13A and 13B illustrate CO₂ capture measurements over time obtained with the different sorbents under the Test D* conditions (CO₂: 420 ppm, 30° C. and 45% RH).

FIGS. 14A and 14B illustrate CO₂ capture measurements over time obtained with various sorbents constituted of calcium hydroxide powder with two levels of porosity, and different concentrations of NaCl, under the Test D* conditions (CO₂: 420 ppm, 30° C. and 45% RH).

### DETAILED DESCRIPTION

The present disclosure will now be described more fully hereinafter with reference to the accompanying drawings, in which embodiments of the present disclosure are shown. This disclosure may however be embodied in many different forms and should not be construed as limited to the embodiments set forth herein, rather, these embodiments are provided for thoroughness and completeness.

For the process of direct capture of carbon dioxide in air according to the present disclosure, a calcium hydroxide-based composition is provided, said calcium hydroxide-based composition comprising Ca(OH)₂ and an ionic compound with a content of 0.05% or higher than 0.05% by weight relative to the content of Ca(OH)₂, preferably higher than 0.25% by weight relative to the content of Ca(OH)₂, more preferably higher than 1.0% by weight relative to the content of Ca(OH)₂ but less than 10.0% by weight relative to the content of Ca(OH)₂, preferably less than 7.0% by weight relative to the content of Ca(OH)₂, more preferably less than 5.0% by weight relative to the content of Ca(OH)₂, in particular less than 2.0% by weight relative to the content of Ca(OH)₂, said ionic compound comprising an alkali and/or alkali earth metal cation and optionally said ionic compound being different from any element of the group consisting of Ca(OH)₂, CaCO₃, Mg(OH)₂ and MgCO₃, preferably said ionic compound comprising at least one of a hydroxide, halogen and/or carbonate anion.

More specifically, the calcium hydroxide-based calcium composition is preferably obtained with the following preparation steps:
a) Providing lime particles with an available CaO of greater than 80%, preferably greater than 93% by weight relative to the total weight. By available CaO content (determined in accordance with EN 459-2, paragraph 6.9, (version of July 2021)), it is meant the content contained in the quicklime, and optionally in the hydrate in the event that slight hydration of lime occurs prior to hydration. This content does not include the CaO contained in the carbonate (CaCO₃) and in the sulfate (CaSO₄) which are not effective for the subsequent capture of CO₂ in air. The lime particles also have a sulfur content that is as low as possible, namely below 0.2% and preferably between 0.01 and 0.07% by weight. The MgO content thereof is lower than 8%, and preferably lower than 3% and even 2% by weight, and the CO₂ content is 1.5 weight % or lower. As is conventional, the lime may also contain impurities such as aluminum oxide, iron, manganese or silicon. The lime particles typically have a particle size distribution of between 0 and 3 mm, 0 and 10 mm, 2 and 10 mm or 5 and 25 mm. The lime can also be milled lime of micrometric size, for example having a particle size distribution of between 0 and 100 μm. Preferably, the lime particles have a t60 less than 1000 s, preferably less than 300 s, and particularly preferably less than 60 s, the t60 being measured according to the EN459-2 standard, paragraph 7.6 (version of July 2021).
b) Hydration is performed with a water/lime weight ratio of between 0.4 and 3 or above 3 and preferably between 0.6 and 2, preferably between 0.6 and 1.2, in particular 1 and 1.05, to obtain a mixture having no residual humidity or a residual humidity of 10% by weight or higher and preferably between 20% to 85% by weight, in particular 25% and 30% by weight. Typically, the temperature of the water is between 1° and 40° C. Hydration is preferably performed in the presence of a hydration-delaying additive comprising at least one hydroxyl chemical function (—O—H) and/or (NHx, with x=1, 2 or 4) in a proportion of at least 0.4 weight % relative to the lime fed into the hydrator. More preferably, the content of additive is between 0.5 and 5 weight % of the quicklime source (said lime particles with an available CaO of greater than 80%, preferably greater than 93%), but for reasons of economy it is rather more limited to a range of 0.5 to 4.5 weight %, further preferably 0.5 to 3.5 weight %, even 0.5 to 2.5% or even between 0.5 and 1.5 weight %. The additive can be selected from the non-exhaustive list comprising ethylene glycol, diethylene glycol, triethylene glycol, monoethano-lamine, diethanolamine, triethanolamine, monopropylene glycol, dipropylene glycol, the mixtures and derivative products thereof.
c) optionally drying said mixture to form a dried hydrate mixture having a residual moisture of at least than 5%, preferably at least 7% by weight relative to the total weight of said mixture.

The calcium hydroxide based composition can be provided in the form of a malleable or flowable composition, shaped bodies or powders.

A malleable or flowable composition can be obtained via the above mentioned preparation directly or indirectly.

In the case of a direct preparation, the malleable or flowable composition is the result of a slaking with a water/lime weight ratio above 1.21 without further dilution or a water/lime weight ratio between 0.75 and 1.2 followed by a dilution. The slaking can be combined with one or more additives. The introduction of the ionic compound according to the present disclosure such as NaOH, KOH, NaCl, KCl, Na₂CO₃, K₂CO₃ or any combination thereof can take place during the slaking process.

In the case of an indirect preparation, the malleable or flowable composition is prepared via mixing a dried calcium hydroxide-based powder composition obtained with water/lime weight ratio of between 0.75 and 1.2. The mixing can be combined with the introduction of the ionic compound according to the present disclosure, such as NaOH, KOH, NaCl, KCl, Na₂CO₃, K₂CO₃ or any combination thereof and optionally one or more additives. The resulting malleable or flowable composition obtained via the slaking or mixing has typically a water content above 35% by weight of said composition, and optionally at most 85% by weight of said composition. A flowable or malleable composition can be a putty lime or a milk of lime.

The malleable or flowable composition can be used as a sorbent to be carbonated in a contactor or as a precursor for a sorbent shaped body. In the latter case, the malleable or flowable composition can be shaped into 3D printings or pellets or other forms obtained by extrusion (e.g. WO1999061373A1). Preferably, the shaped bodies obtained have at least one dimension greater than 3 mm. Preferably a given shaped body has an apparent density lower than 1.4 g/cm³, preferably lower than 1.1 g/cm³ and preferably higher than 0.8 g/cm³. The apparent density characterizes the pore porosity within the particles forming the shaped body but also the intraparticle void volume between the same particles. The intraparticle void volume promotes gas diffusion from the envelope of the shaped body to the pores of the particles forming said shaped body. Optionally, the shaped bodies can be contacted with air or a CO₂-rich atmosphere so as to pre-carbonate them and therefore enhance their mechanical strength. Prior to the shaping of the shaped bodies, the malleable or flowable composition can be mixed with at least one element selected from the group comprising support particles, at least one of the ionic compound according to the present disclosure, such as NaOH, KOH, NaCl, KCl, Na₂CO₃, K₂CO₃ or any combination thereof (in case it is was not done at an earlier stage or in case of top up addition), shaping additive, water, or any combination thereof.

A calcium hydroxide-based powder composition obtained with the above mentioned process with water/lime weight ratio of between 0.4 and 1.2 can directly applied on a contactor surface providing that the ionic compound according to the present disclosure, such as NaOH, KOH, NaCl, KCl, Na₂CO₃, K₂CO₃ or any combination thereof has been introduced in said composition either during the slaking or subsequent to the slaking. The subsequent introduction can be a mixing of the calcium hydroxide powder and an ionic compound-based powder. Alternatively, the ionic compound powder is first dissolved in an aqueous solution before being combined with the calcium hydroxide powder. The resulting composition is preferably stirred to achieve a homogeneous concentration of the ionic compound additive. It is not necessary to dry the composition, as it has been observed that the residual water content evaporates within a few hours.

A calcium hydroxide-based powder composition obtained with the above mentioned process with water/lime weight ratio of between 0.4 and 1.2 can be used a precursor for forming shaped bodies. Then, the calcium hydroxide-based powder composition is shaped into pellets, granules, extrudates, 3D printings or compacts such as tablets or briquettes, preferably said shaped bodies having at least one dimension greater than 3 mm. Examples of shaping devices for calcium based particulates are disclosed in WO2021078878A1, WO2016110572A1, WO2018007634A1, WO2018007630A1. Eventually, the shaped bodies can be contacted with air or a CO₂—containing atmosphere so as to pre-carbonate them and therefore enhance their mechanical strength. Advantageously, prior the shaping the calcium hydroxide powder composition is mixed with at least one element selected from the group comprising, support particles, at least one shaping additive, water, or any combination thereof.

Preferably a given-shaped body has an apparent density lower than 1.4 g/cm³, more preferably lower than 1.1 g/cm³ and in particular higher than 0.8 g/cm³. The apparent density characterizes the pore porosity within the particles forming the shaped body and the intraparticle void volume between the same particles. The intraparticle void volume promotes gas diffusion from the envelope of the shaped body to the pores of the particles forming said shaped body. The apparent (particle/extrudate/envelope) density (a.k.a. oil density) of an extrudate is a measurement for the degree of porosity of the extrudate and is expressed as the mass of an extrudate divided by its apparent/envelope extrudate volume, i.e. the volume calculated from the outer dimensions of the extrudate. The apparent density takes into account the volume of solid material of the extrudates and the volume of the closed and open pores of the extrudate. The measurement of the apparent density can be measured by oil intrusion porosimetry. The apparent density can be determined by intrusion of sunflower oil, according to a measuring protocol resulting from the ISO 5017 standard. The measurements are carried out on at least 3 representative extrudates. For each extrudate, the measure is repeated twice. It should be noted that the extrudates are dried for the measurement.

In any case, the ionic compound according to the present disclosure, such as NaOH, KOH, NaCl, KCl, Na₂CO₃ or K₂CO₃, is introduced in said composition in at least one of the preparation phases: the slaking and a mixing phase before the shaping. The introduction can involve mixing the calcium hydroxide powder with an ionic compound-based powder or an aqueous solution of the ionic compound, preferably with stirring to achieve a homogeneous concentration of the ionic compound additive, and optionally drying if necessary.

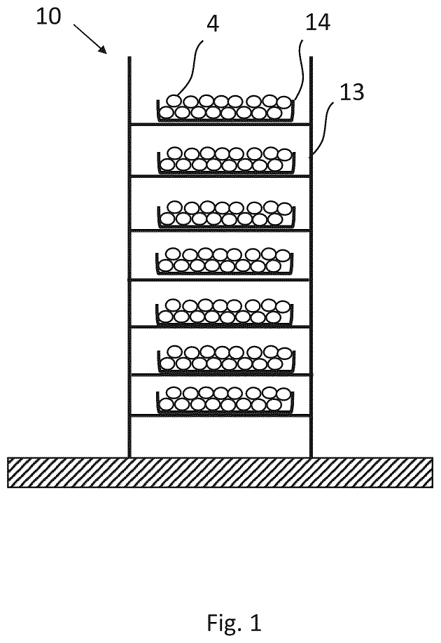

FIG. 1 shows a contactor 10 in the form of a shelf 13 with baskets 14 according to an embodiment of the present disclosure. The baskets 14 contain shaped bodies 4 of calcium hydroxide-based material that are exposed to natural airflow.

Typically, a malleable or flowable composition, such as milk of lime can be used as a coating precursor. The milk of lime is, for this purpose, applied on a support surface. For instance, the support surface, such as a plate is immersed in a receptacle containing a milk of lime before being extracted thereof. The milk of lime comprises an ionic compound according to the present disclosure, such as NaOH, KOH, NaCl, KCl, Na₂CO₃, K₂CO₃ or any combination thereof. Over time, the malleable or flowable layer will dry and form an adhering layer on the support surface. The calcium hydroxide composition in the layer will carbonate in contact with the CO₂ present in the air.

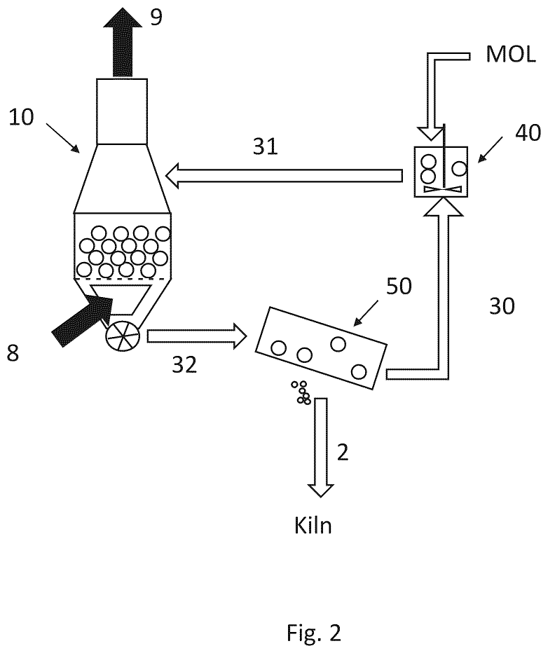

For instance, FIG. 2 shows a direct air capture process using beads coated with sorbents according to a further embodiment of the present disclosure. The beads are immersed in a bath 40 of milk of lime MOL according to the disclosure (it contains an ionic compound according to the present disclosure, such as NaOH, KOH, NaCl, KCl, Na₂CO₃, K₂CO₃ or any combination thereof). The coated beads are then dried, forming a calcium hydroxide outer layer. A contactor 10 is adapted to receive beads coated with calcium hydroxide sorbent 31. Within the contactor 10, the calcium hydroxide layer undergoes carbonatation upon contact with the CO₂ present in the air. In FIG. 2, air 8 is blown to expedite the pace of the carbonation reaction. The beads are arranged in a stack on an openwork structure. Beads coated with fresh sorbents 31 are continuously introduced at the top of the bead stack, while beads with a carbonated coating 32 are continuously discharged from the bottom of the bead stack. Once the beads are extracted from the contactor 10, they are fed into a separation device such as a rotating trommel 50, where the carbonated outer layer is peeled off. The bead cores 30 are then routed to the milk of lime bath 40 to repeat the process. The carbonated materials are collected from the rotating trommel 50 and transferred to a kiln so that the sorbent can be regenerated.

Furthermore, a flowable or malleable composition containing the ionic compound according to the present disclosure, such as NaOH, KOH, NaCl, KCl, Na₂CO₃, K₂CO₃ or any combination thereof can be a precursor for a sorbent-shaped body. One or more of these sorbent-shaped bodies can be used for CO₂ capture in air. To this end, the shaped bodies are placed in or on a stationary or moving support or containment device selected from a non-exhaustive group comprising: trommel, plate, bucket, pile, tray, filter media, cartridge, grate, tile, wall, brick, carbonated product, net, ground and gabion. Preferably, shaped bodies have a water content of at least 5%, preferably at least 10%, and/or at most 20%, preferably at most 15% by weight of said bodies. A drying step may be required for the shaped bodies obtained from a malleable or flowable composition to reach the above-mentioned water content range.

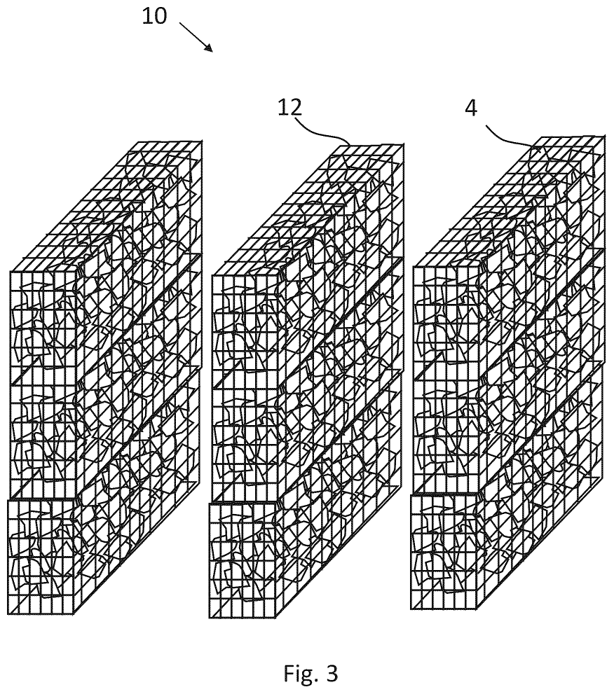

FIG. 3 shows a contactor 10 in the form of gabions 12, according to a further embodiment of the present disclosure. The gabions 12 contain shaped bodied 4 obtained with the above-mentioned flowable or malleable composition according to the present disclosure (containing the ionic compound according to the present disclosure, such as NaOH, KOH, NaCl, KCl, Na₂CO₃ or K₂CO₃). The gabions 12 can be stacked on the ground outside or inside. This direct air approach requires a minimum management as the gabions 12 can be left unattended and then collected once sufficiently carbonated. Alternatively, the shaped bodied 4 can be formed with a powder composition according to the present disclosure.

Moreover, a calcium hydroxide-based powder composition (containing the ionic compound according to the present disclosure, such as NaOH, KOH, NaCl, KCl, Na₂CO₃, K₂CO₃ or any combination thereof) can be placed in or on a stationary or moving support selected from the non-exhaustive group comprising: trommel, plate, bucket, pile, tray, filter media, such as clothes or bags in a bag filter, cartridge, grate, tile, wall, brick, carbonated product ground and net. Preferably, the hydroxide-based powder composition supplied to the support has a water content of at least 5% by weight, preferably at least 10% by weight, and/or at most 20% by weight, preferably at most 15% by weight of said composition. The water content could be lower than 5%. While a reduction of the water content below the threshold of 5% should not be excluded, a minimum water content is advantageous as water facilitates the kinetics of the carbonation process at low temperatures (e.g., 2° C. to 50° C.), which is primarily governed by ionic reactions.

The calcium hydroxide-based powder composition in the form of powders containing the ionic compound according to the present disclosure, such as NaOH, KOH, NaCl, KCl, Na₂CO₃, K₂CO₃, or combination thereof can also serve as a sorbent in a packed bed (e.g., fixed bed or moving bed) or fluidized bed such as a bubbling bed, a spouted bed, a circulating fluidized bed or an entrained bed. Alternatively, small sorbent-shaped bodies with dimension lower than 10 mm can also be used in a packed bed or fluidized bed.

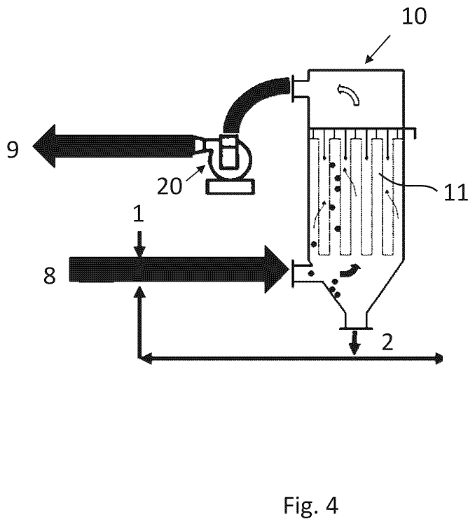

A powder-based sorbent composition containing the ionic compound according to the present disclosure, such as NaOH, KOH, NaCl, KCl, Na₂CO₃, K₂CO₃, or any combination thereof can also be used for capturing CO₂ in air in combination with a filtering media such as clothes or bags in a bag filter. For instance, FIG. 4 shows a direct air capture process using a filter media 11 to filter the sorbent according to an embodiment of the present disclosure. Fine calcium hydroxide-based particles 1 are introduced into an air flow 8. These particles 1 are carried along by the airflow 8 to the contactor 10 containing the filtering media 11, where they are maintained in contact with the airflow 8, ensuring the capture of CO₂. The depleted air flow 9 is removed from the contactor using a fan. The filtering media 11, particularly the bag filters are periodically cleaned by reversing the airflow or by injecting a pulse of compressed air on the clean side of the bags to discharge the sorbent 2 from the bag filters for collection. The collected sorbent can then undergo a decarbonation process, such as in a kiln (not shown). Optionally, a fraction of the collected sorbent 2 can be recycled to the airflow 8 as illustrated in FIG. 4. Optionally, the collected sorbent 2 can be separated according to conversion level, the leaner sorbent being recycled and the sorbent richer in carbonate being separated for further processing (decarbonation).

A calcium hydroxide-based composition in the form of a malleable or flowable composition, shaped bodies or powders, according to the present disclosure (containing the ionic compound according to the present disclosure, such as NaOH, KOH, NaCl, KCl, Na₂CO₃, K₂CO₃ or any combination thereof) can be directly exposed to ambient air or to conditioned air.

One or more of the following parameters of the conditioned air can be adjusted in order to enhance the degree of conversion and, optionally the kinetics thereof: an air flow rate/speed, an air temperature, an air relative humidity, and an air absolute humidity.

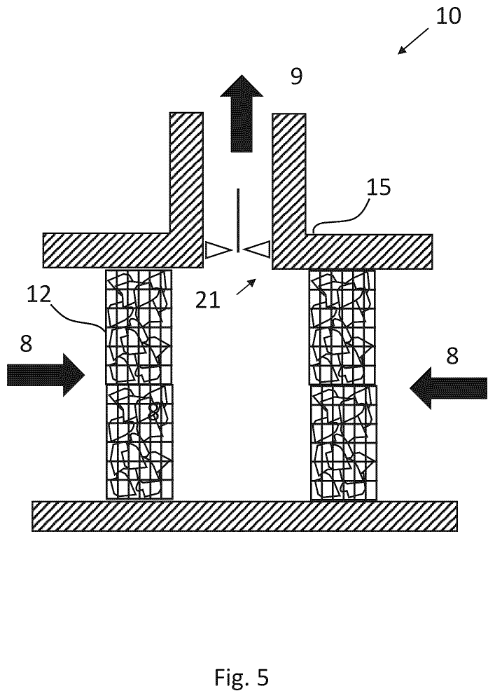

The embodiment of FIG. 5 differs from that of FIG. 3, in that the gabions 12 are integrated into a structure that enables control of the carbonatation process. This structure includes a covering element 15 on top of the gabions. A fan is positioned within the covering element 15. The fan 21 is operated to continuously draw air 8 through the opposed stacks formed by the gabions 12. This configuration establishes a flow path with inlets on the outer sides of the stacks and an outlet positioned downstream from the fan 21. Optionally, the airflow drawn 8 is adjusted by adjusting the speed of the fan 21 depending on the CO₂ concentration in vented air 9. For instance, the fan rotational speed (via variable speed drive) is controlled by measuring the CO₂ concentration at the contactor outlet.

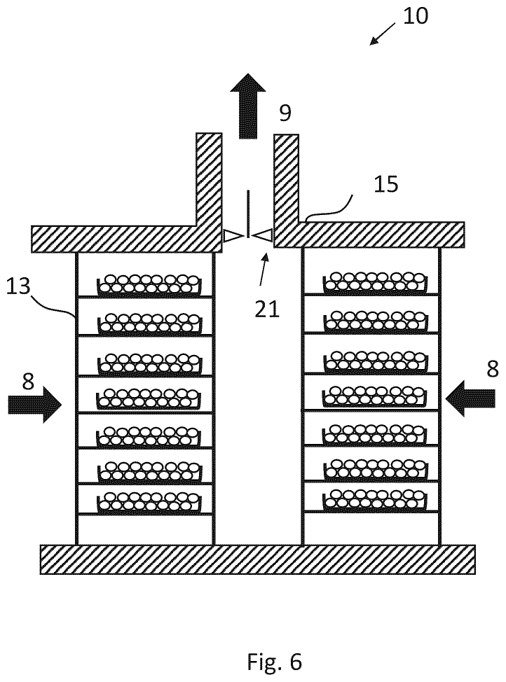

FIG. 6 depicts an alternative embodiment to the gabions shown in FIG. 5, where baskets 13 containing the shaped bodies 4 of calcium hydroxide-based composition according to the present disclosure are arranged on shelves 12. In an alternative embodiment, the shaped bodies can be replaced by powder, milk of lime or lime putty.

Similarly, the characteristics of the sorbent can be adjusted in order to optimize the conversion by modifying at least one of following: the flow rate of a calcium hydroxide-based composition, the residence time of the calcium hydroxide-based composition, the inventory of a calcium hydroxide-based composition and/or an absolute water content inside the calcium hydroxide-based composition.

Theses parameters (air characteristics and/or sorbent characteristics) can be adjusted by one of the following control means, such as valves, guiding blade, fans, blowers, humidifiers, coolers, and/or heaters. Equally means for forming ridges on surface of the powder composition or for stirring the composition (e.g. with beater) can be employed to homogenize said calcium hydroxide, thereby preventing stratification.

Preferably, the calcium hydroxide-based sorbent composition containing the ionic compound according to the present disclosure, such as NaOH, KOH, NaCl, KCl, Na₂CO₃, K₂CO₃ or any combination thereof can be placed in an airflow channel that comprises an airflow inlet and an airflow outlet. In this setup, one or more of the aforementioned conditioned air characteristics are adjusted based on element such as weather conditions, particularly an ambient air temperature and/or an air relative humidity as measured or estimated at the air flow inlet. The carbonation process can be monitored by considering the carbonate content in said composition at one or more locations and/or the difference in CO₂ concentration between the airflow inlet and flow outlet, in particular the airflow should be adapted according to capture rate at a given time. A parameter that commonly affects carbonation is humidity level, and as such, the humidity of the air in contact with the sorbent composition. This parameter can be controlled to maintain an elevated level of humidity. Alternatively or complementary, the sorbent can be humidified in a controlled manner to regulate its moisture content.

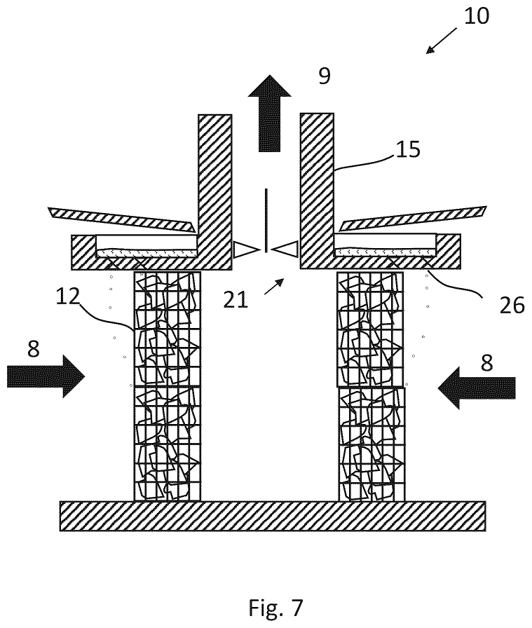

The embodiment according to FIG. 7 differs from that of FIG. 5 in that it includes humidifying means with a water collector to maintain the relative humidity above a certain threshold to promote carbonation. Typically, one or more humidity sensors (not shown) can be placed on the outer sides of the gabions 12. Based on the humidity measurement, the draining valves 26 of the humidifying means positioned above the gabions 12 are opened or closed to regulate the water supply. One or more CO₂ sensors (not shown) can be disposed upstream and downstream of the gabions 12 to monitor the CO₂ in the air; and then indirectly determine the capture rate in the gabions 12 and then determine the timing for collecting the carbonated materials. A heating system (not illustrated) can be also provided in order to operate at low temperature and prevent freezing. The energy for driving the fan 21, the controller and valves 26, and optionally the heater can be provided by a power source such as a solar panel mounted on the covering element.

The calcium hydroxide-based sorbent composition containing the ionic compound according to the present disclosure, such as NaOH, KOH, NaCl, KCl, Na₂CO₃, K₂CO₃ or any combination thereof is intended to be exposed to temperatures lower than 39° C. or equal to 39° C. and optionally the temperatures being greater than 0° C. and/or relative humidity levels falling within the range of 10% to 95%, preferably 70 to 100%. To achieve this, the contactor(s) can be strategically located in areas with suitable weather conditions that provide optimal carbonatation. If the desired weathers conditions cannot be guaranteed in the available locations, air conditioning can be implemented to compensate for climatic variations and maintain the humidity and temperature within appropriate ranges, in particular with high relative humidity (70% to 100%) and/or low temperatures (5° to 15° C.). In cases where the DAC locations (usually driven by sequestration capacities) are unsuitable due to climate constraints, limited access to energy sources, the calcium hydroxide-based composition according to the present disclosure demonstrates surprising adaptability for CO₂ capture in air with low relative humidity and elevated temperature, making it efficient even in arid climates.

It should be emphasized that the calcium hydroxide-based composition according to the present disclosure (containing the compound, such as NaOH, KOH, NaCl, KCl, Na₂CO₃, K₂CO₃ or any combination thereof) also performs well for carbonation in a rich CO₂ atmosphere such as flue gas. The carbonation reaction is typically effective at elevated temperatures, e.g. ranging from 450° C. up to 600° C. This type of carbonation is commonly referred to as high-temperature carbonation, in contrast to the low/ambient temperature (e.g. 2° C. to 50° C.) carbonation encountered in CO₂ capture from air (also known as Direct Air Capture). The composition can also be used for example for flue gases at temperature higher than ambient but still moderate, for example above 100 or 120° C. Furthermore, when appropriate in the context, the term “air” used herein can be replaced by “CO₂ containing gas”, for example, flue gas. Moreover, the present disclosure can be envisaged to treat a mixture of air mixed with flue gas.

After exposure to air, the carbonate sorbent generally takes the form of powders, agglomerated powders, coated layers, or shaped bodies. Depending on the carbonation conditions, the carbonated sorbent particles may become worn or fused together. It is advantageous to collect the carbonated sorbent once the molar conversion of Ca(OH)₂ into CaCO₃ reaches a predefined level. The level of conversion can be determined by the CO₂ content present in the carbonated composition. To evaluate the conversion level, a sample of the carbonated sorbent can be taken and analyzed in a lab. Alternatively, in-situ monitoring can be implemented using an analyzer to measure the chemical composition of the sorbent directly in or on the contactor in real-time or at regular intervals. Additionally, a model-based predictive algorithm can be used to estimate the conversion level based on recorded atmospheric data. Achieving an elevated level of conversion reduces the energy needed for decarbonation, as any unreacted calcium hydroxide would be unnecessarily heated and de-hydrated in a calciner.

The collected calcium carbonate can be effectively conditioned to increase its calcium carbonate content before undergoing decarbonation to address the aforementioned limitations.

Such conditioning includes at least one of drying, grinding, milling, classifying, dehydroxylating or purifying the collected calcium carbonate-based composition, or any combination thereof. Specifically, the purification step involves separating the ionic compound according to the present disclosure, such as NaOH, KOH, NaCl, KCl, Na₂CO₃, K₂CO₃ or any combination thereof and some of the unreacted calcium hydroxide from the collected calcium carbonate-based composition. This can be achieved through purification processes such as air classification, leaching, peeling, flotation, or any combination thereof.

Then, the raw, conditioned, or purified carbonate sorbent is decarbonated to be either recycled for further direct capture applications or for another purpose. During the decarbonation process, CO₂ is extracted from the collected calcium carbonate-based composition through direct or indirect calcination, electrochemistry, or chemical attack. In indirect calcination (in which combustion is done in a separate chamber and heat pass through a wall to reach the material to be treated), heat can be supplied by the combustion of carbon-neutral fuels, hydrogen combustion, or electric heaters. In direct calcination, heat can be generated by air-based combustion of carbonous fuel/H₂. The exhaust gas generated during the process can be treated in a post-combustion CO₂ capture system, such as amine gas treating or pressure swing absorption. Oxyfuel firing (using carbonous fuel and/or H₂), can also be considered. Alternatively, electrical heat input methods such as plasma or induction can be used. Electrochemistry involves performing electro-dissolution, while in a chemical attack, the carbonated material can react with a strong base such as NaOH or a strong acid such as HCl.

It should be noted that the presence of the ionic compound additive allows to operate at negative temperature as water will not solidify at 0° C.

The heat released during the slaking process or the sensible thermal energy in the decarbonated materials can be advantageously recovered in several applications such as for preheating the carbonated materials or for drying the slaked lime. Therefore, it is advantageous to have the hydration unit and the decarbonation unit located in the same facility. This measure would also reduce the transportation and stock duration. Compared to a CaO-based sorbent used in direct air capture process, a Ca(OH)₂-based sorbent permits recovery of the hydration enthalpy of CaO (e.g. during the slaking with heat recovery installation). With a CaO-based sorbent, the hydration enthalpy of CaO is lost in the atmosphere during a combined hydration and carbonation process with CO₂ and H₂O present in air.

To illustrate the present disclosure, two types of calcium hydroxide powder compositions were prepared.

As raw materials, an industrial soft burnt quicklime with the following characteristics was used:

TABLE 1A

| | Reactivity (t60) | C(% wt.) | S (% wt.) |
|---|---|---|---|
| Quicklime source | 36 sec | 0.229 | 0.014 |

TABLE 1B
Quicklime particle seize distribution

| | Sieve size | | | | | | | | | |
|---|---|---|---|---|---|---|---|---|---|---|
| | 250 | 400 | 630 | 1120 | 1600 | 2000 | 2500 | 4000 | 7100 | 10000 |
| | μm | μm | μm | μm | μm | μm | μm | μm | μm | μm |
| Cumulative | 21.2 | 27.2 | 33.4 | 42.9 | 50.1 | 55.1 | 60.7 | 73.5 | 92.3 | 98.1 |
| passing % | | | | | | | | | | |

TABLE 1C
Quicklime composition

| Al₂O₃ | Fe₂O₃ | MgO | SiO₂ | CaO available |
|---|---|---|---|---|
| (%) | (%) | (%) | (% Ox) | (sugar titration) |
| 0.05 | 0.06 | 0.53 | 0.22 | 92.1% |

The reactivity of quicklime was evaluated using t60 parameter which corresponds to the time needed to raise the temperature of the lime/slaking water system up to 60° C., slaking of the lime being conducted following the protocol described in the standard EN 459-2 § 7.6 (July 2021 version).

Chemical composition was measured using ICP-OES (inductively coupled plasma-optical emission spectroscopy).

Two types of hydrated lime were produced with the same quicklime source as described in Tables 1A, 1B and 1C.

The first type of hydrated lime (Calcium hydroxide No1, No3, No5) is a hydrated lime with low porosity. Calcium hydroxide No1 is obtained by mixing one kilogram of the quicklime source with a water/lime weight ratio of 1.05 in a laboratory mixer with no delaying additive. After completion of the hydration reaction, the residual humidity (free moisture) was determined by measuring the mass loss following heating the samples at 150° C. for 2 hours in a drying oven (EN 459-2 § 6.5 Jul. 2021 version). The dried product was ground to break calcium hydroxide agglomerates and reduce particle size to below 250 μm. Calcium hydroxides No3 and No5 were prepared, respectively, with the quicklime source under similar experimental conditions to those described above for Calcium hydroxide No1.

The second type hydrated lime (calcium hydroxide No2, No4, and No6) is a hydrated lime with high porosity. In particular, Calcium hydroxide No2 is obtained by mixing one kilogram of the quicklime source with a water/lime weight ratio of 1.05 in a laboratory mixer with a delaying additive (diethylene glycol; 1% weight relative to the quicklime source). After completion of the hydration reaction, the residual humidity (free moisture) was determined by measuring the mass loss following heating the samples at 150° C. for 2 hours in a drying oven (EN 459-2 § 6.5 Jul. 2021 version). The dried product was ground to break calcium hydroxide agglomerates and reduce particle size to below 250 μm. Calcium hydroxides No4 and No6 were prepared, respectively, with the quicklime source under similar experimental conditions to those described above for Calcium hydroxide No2.

The hydrates obtained were characterized as follows. The BET specific surface area of the powders was measured in accordance with standard ISO9277, second Edition of Sep. 1, 2010. The pore volume and pore distribution as a function of pore diameter were calculated based on the step-by-step analysis of the isotherm desorption branch using the BJH method of Barrett, Joyner and Halenda (1951), conventionally used with 77K nitrogen as adsorbent gas. The method is described in standard DIN66134 (February 1998 version). It allows the calculation of pore volume distribution as a function of pore diameter on the assumption that the pores are cylindrical. The pore volume and pore volume distribution were determined for the range of pores having a diameter ranging from 20 to 1000 Å. On the basis of pore volume distribution determined with the BJH method, the BJH pores size distribution of the pores was also calculated per interval of 100 Å again assuming the pores are cylindrical.

TABLE 2

| Calcium | | C | S | CO₂ | SS | |
|---|---|---|---|---|---|---|
| hydroxide | | (% | (% | (% | BET | Vp |
| (batch) No | Type | wt.) | wt.) | wt.) | (m²/g) | (cm³/g) |
| 1 | Low porosity | 0.2 | 0.007 | | 21.538 | 0.149 |
| 2 | High porosity | 0.5 | 0.013 | | 44.385 | 0.213 |
| 3 | Low porosity | | | 2.294 | 16.12 | 0.1 |
| 4 | High porosity | | | 3.447 | 36.346 | 0.178 |
| 5 | Low porosity | | | | 15.228 | 0.1 |
| 6 | High porosity | | | | 35.21 | 0.16 |

The ionic compound additive was mixed with two types of calcium hydroxide (high and low porosity), with the addition of 24 grams of water for every 1000 grams of calcium hydroxide. The mixture was stirred in a mixer (Hobart) for 20 minutes. The addition of water allows the ionic compound additive to dissolve, enabling it to penetrate the pores of the calcium hydroxide samples, thereby ensuring its catalytic role. The treated calcium hydroxide samples have a residual humidity of approximately 16% by weight. The tests in the present disclosure are based on samples where the ionic compound is added via a solution. The effects of the present disclosure are also achievable when the ionic compound in dry form is mixed with the hydrated lime, either in its dry or wet form.

### Example

Sixteen compositions undried were tested to identify the best ionic compounds under different temperature and humidity conditions. These compositions have the following characteristics:

TABLE 3

| | Calcium | | | | | | |
|---|---|---|---|---|---|---|---|
| Sample | hydroxide | | Additive wt./ | SS BET | Vp | | |
| No | (batch) No | Additive | sample wt. | (m²/g) | (cm³/g) | C(%) | S(%) |
| 1 | 1 | | 0.0% | 15.9 | 0.105 | 0.43 | 0.01 |
| 2 | 1 | NaCl | 1.0% | 15.04 | 0.104 | 0.41 | 0.01 |
| 3 | 1 | KCl | 1.0% | 15.24 | 0.106 | 0.4 | 0.01 |
| 4 | 1 | NaOH | 1.0% | 14.28 | 0.09 | 0.35 | 0.01 |
| 5 | 1 | Na₂CO₃ | 1.0% | 14.38 | 0.092 | 0.49 | 0.01 |
| 6 | 1 | K₂CO₃ | 1.0% | 14.55 | 0.092 | 0.53 | 0.01 |
| 7 | 1 | MgCl₂ | 1.0% | 7.53 | 0.027 | 0.38 | 0.01 |
| 8 | 1 | CaCl₂ | 1.0% | 7.19 | 0.026 | 0.37 | 0.01 |
| 9 | 2 | | 0.0% | 27.332 | 0.169 | 0.759 | 0.012 |
| 10 | 2 | NaCl | 1.0% | 27.759 | 0.163 | 0.742 | 0.013 |
| 11 | 2 | KCl | 1.0% | 26.309 | 0.164 | 0.74 | 0.01 |
| 12 | 2 | NaOH | 1.0% | 26.139 | 0.16 | 0.782 | 0.007 |
| 13 | 2 | Na₂CO₃ | 1.0% | 27.459 | 0.174 | 0.855 | 0.007 |
| 14 | 2 | K₂CO₃ | 1.0% | 28.818 | 0.175 | 0.838 | 0.005 |
| 15 | 2 | MgCl₂ | 1.0% | 19.477 | 0.113 | 0.734 | 0.011 |
| 16 | 2 | CaCl₂ | 1.0% | 21.813 | 0.132 | 0.713 | 0.011 |

Sample No. 1 is composed of hydrated lime with a low level of porosity (Calcium hydroxide No1) and does not contain any ionic compound. It serves as a reference.

Samples No. 2 to 8 illustrate the influence of the selected ionic compound on the efficacy of CO₂ capture using sorbent compositions with a hydrated lime having a low level of porosity (calcium hydroxide No1).

Sample No. 9 is composed of hydrated lime with a high level of porosity (calcium hydroxide No2) and does not contain any ionic compound. It serves as a reference.

Samples No. 10 to 16 illustrate the influence of the selected ionic compound with a hydrated lime having a high level of porosity (calcium hydroxide No2), on CO₂ capture efficacy.

Twelve additional compositions were tested to assess the influence of a higher concentration of the ionic compound under less favorable weather conditions for carbonation. These compositions have the following characteristics:

TABLE 4

| | Calcium | | | | | | |
|---|---|---|---|---|---|---|---|
| Sample | hydroxide | | | Additive wt. | SS BET | Vp | Test D* |
| No | (batch) No | Type | Additive | sample wt. | (m²/g) | (cm³/g) | (wt. % CO₂) |
| 17 | 3 | Low porosity | | 0.0% | 16.126 | 0.1 | 12.28 |
| 18 | 3 | Low porosity | NaCl | 5.0% | 11.9 | 0.087 | 40.79 |
| 19 | 3 | Low porosity | KCl | 5.0% | 11.501 | 0.101 | 32.87 |
| 20 | 3 | Low porosity | NaOH | 5.0% | 6.066 | 0.027 | 27.06 |
| 21 | 3 | Low porosity | Na₂CO₃ | 5.0% | 11.283 | 0.064 | 32.87 |
| 22 | 3 | Low porosity | K₂CO₃ | 5.0% | 10.916 | 0.089 | 27.83 |
| 23 | 4 | High porosity | | 0.0% | 36.346 | 0.178 | 14.71 |
| 24 | 4 | High porosity | NaCl | 5.0% | 23.205 | 0.14 | 35.60 |
| 25 | 4 | High porosity | KCl | 5.0% | 22.421 | 0.138 | 35.15 |
| 26 | 4 | High porosity | NaOH | 5.0% | | 0.09 | 21.05 |
| 27 | 4 | High porosity | Na₂CO₃ | 5.0% | 21.892 | 0.132 | 27.31 |
| 28 | 4 | High porosity | K₂CO₃ | 5.0% | 23.677 | 0.138 | 24.46 |

Sample No. 17 is composed of a hydrated lime with a low level of porosity (calcium hydroxide No3) and does not contain any ionic compound. It serves as a reference.

Samples No. 18 to 22 illustrate the influence of the selected ionic compound on the efficacy of CO₂ capture using sorbent compositions with a hydrated lime having a low level of porosity (calcium hydroxide No3).

Sample No. 23 is composed of a hydrated lime with a high level of porosity (calcium hydroxide No4) and does not contain any ionic compound. It serves as a reference.

Samples No. 24 to 28 illustrate the influence of the selected ionic compound in sorbent compositions, with hydrated limes having a high level of porosity (calcium hydroxide No4), on CO₂ capture efficacy.

Fourteen supplementary compositions were tested to assess different concentrations of a specific ionic compound under less favorable weather conditions for carbonation. These compositions have the following characteristics:

TABLE 6

| | Calcium | | | | | | |
|---|---|---|---|---|---|---|---|
| Sample | hydroxide | | | Additive wt./ | SS BET | Vp | Test D |
| No | (batch) No | Type | Additive | sample wt. | (m²/g) | (cm³/g) | (wt % CO₂) |
| 29 | 5 | Low porosity | | 0.0% | 15.228 | 0.1 | 13.6 |
| 30 | 5 | Low porosity | NaCl | 0.25% | 14.232 | 0.102 | 25.6 |
| 31 | 5 | Low porosity | NaCl | 0.5% | 14.037 | 0.096 | 32.4 |
| 32 | 5 | Low porosity | NaCl | 1.0% | 13.238 | 0.107 | 39.0 |
| 33 | 5 | Low porosity | NaCl | 2.0% | 13.57 | 0.096 | 39.6 |
| 34 | 5 | Low porosity | NaCl | 4.0% | 12.425 | 0.111 | 38.8 |
| 35 | 5 | Low porosity | NaCl | 6.0% | 12.585 | 0.095 | 39.3 |
| 36 | 6 | High porosity | | 0.0% | 35.21 | 0.16 | 15.43 |
| 37 | 6 | High porosity | NaCl | 0.25% | 29.33 | 0.15 | 19.07 |
| 38 | 6 | High porosity | NaCl | 0.5% | 29.57 | 0.15 | 22.44 |
| 39 | 6 | High porosity | NaCl | 1.0% | 29.05 | 0.15 | 30.85 |
| 40 | 6 | High porosity | NaCl | 2.0% | 27.90 | 0.15 | 37.45 |
| 41 | 6 | High porosity | NaCl | 4.0% | 24.15 | 0.14 | 37.39 |
| 42 | 6 | High porosity | NaCl | 6.0% | 24.01 | 0.14 | 36.82 |

Sample No. 29 is composed of a hydrated lime with a low level of porosity (calcium hydroxide No5) and does not contain any ionic compound. It serves as a reference.

Samples No. 30 to 35 illustrate the influence of the concentration of NaCl on the efficacy of CO₂ capture using sorbent compositions with a hydrated lime having a low level of porosity (calcium hydroxide No5).

Sample No. 36 is composed of a hydrated lime with a high level of porosity (calcium hydroxide No6) and does not contain any ionic compound. It serves as a reference.

Samples No. 37 to 42 illustrate the influence of the concentration of NaCl in sorbent compositions, with a hydrated lime having a high level of porosity (calcium hydroxide No6), on CO₂ capture efficacy.

The CO₂ capture performances of the different samples were studied by placing a 3 mm layer of hydrated material powder in a set of 150 mm×150 mm×3 mm plastic mold placed in one of the two following weathering chambers:
WC1 Weiss Technik CareEvent C/1400/5/30 CO₂;
WC2 ICH Memmert ICH110C.

The first weathering chamber WC1 is equipped with systems to monitor and regulate temperature, relative humidity and CO₂ concentration and two axial fans in order to ensure internal air circulation. The fans have a nominal rotational speed of 1200 rpm and a diameter of 20 cm. The target temperatures and the target relative humidity were selected to represent typical weather conditions. The CO₂ concentration was multiplied by around five times the reference natural CO₂ concentration (400 ppmv) to accelerate the carbonation process at ambient temperature. It is assumed that the results obtained with an enriched CO₂ atmosphere can be extrapolated to atmospheric conditions, considering the low concentration level and narrow range investigated. The temperature, the relative humidity and CO₂ concentration are regulated to remain within the accuracy ranges presented in the table below:

The second weathering chamber WC2 is equipped with systems to monitor and regulate temperature, relative humidity and CO₂ concentration and fan based internal air circulation. The target temperatures and the target relative humidity were selected to represent typical weather conditions. The CO₂ concentration corresponds to the reference natural CO₂ concentration (420 ppmv). The temperature, the relative humidity and CO₂ concentration are regulated to remain within the accuracy ranges presented in the table below:

TABLE 7

| Parameter | WC No | Range | | Accuracy | |
|---|---|---|---|---|---|
| Temperature | 1 | 5-50° | C. | +/−0.5-0.7° | C. |
| | 2 | 10-50° | C. | +/−0.1° | C. |
| Relative | 1 | 5-90% | RH | +/−3-5% | RH |
| humidity | 2 | 10-90% | RH | +/−0.1% | RH |

| | | | | |
|---|---|---|---|---|
| CO₂ | 1 | 400-2000 | ppmv | +/−10% |
| concentration | | 0-20% | volume basis | +/−0.1% |

Hydrated lime samples were tested in the following conditions:

TABLE 8

| | | | Relative | CO₂ | Test |
|---|---|---|---|---|---|
| | WC No | Temperature | humidity | concentration | duration |
| Test A | 1 | 10° C. | 75% | 2000 ppm | 168 hrs |
| Test B | 1 | 30° C. | 75% | 2000 ppm | 168 hrs |
| Test C | 1 | 10° C. | 45% | 2000 ppm | 168 hrs |
| Test D | 1 | 30° C. | 45% | 2000 ppm | 168 hrs |
| Test D* | 2 | 30° C. | 45% | 420 ppm | 168 hrs |

The fresh and additive-enhanced calcium hydroxide samples 1 to 16, containing a moisture content of around 16% after mixing with a solution containing the ionic compound with the dry hydroxide composition with moisture content of around 16% by weight, were placed in the first weathering chamber WC1. It was observed that the samples dried within a few hours in the weathering chamber. The presence of residual humidity in the samples appears to have a secondary influence on the overall CO₂ capture capability of the sample, measured over 168 hours. However, The fresh and additive-enhanced calcium hydroxide samples 17 to 42 were dried in an oven at 130° C. during 24 h under N₂ atmosphere before being placed in the second weathering chamber WC2.

At the end of the experiments for all samples 1 to 42, the CO₂ content was measured according to EN 459-2 § 6.6 mentioned above.

Tables 9, 10 and 11 show the results.

TABLE 9

| | Calcium | | | Additive | Test A | Test B | Test C | Test D |
|---|---|---|---|---|---|---|---|---|
| Sample | hydroxide | | | wt.)/ | (wt. % | (wt. % | (wt. % | (wt. % |
| No | (batch) No | Type | Additive | sample wt. | CO₂) | CO₂) | CO₂) | CO₂) |
| 1 | 1 | Low porosity | | 0.0% | 43.4 | 31.2 | 41.6 | 23.0 |
| 2 | 1 | Low porosity | NaCl | 1.0% | 43.3 | 42.4 | 43.1 | 39.3 |
| 3 | 1 | Low porosity | KCl | 1.0% | 43.3 | 43.0 | 42.3 | |
| 4 | 1 | Low porosity | NaOH | 1.0% | 42.3 | 30.4 | 41.6 | 32.9 |
| 5 | 1 | Low porosity | Na₂CO₃ | 1.0% | 42.7 | 31.2 | 43.0 | 31.7 |
| 6 | 1 | Low porosity | K₂CO₃ | 1.0% | 42.8 | 30.2 | 41.4 | 32.9 |
| 7 | 1 | Low porosity | MgCl₂ | 1.0% | 43.0 | | 45.3 | 18.3 |
| 8 | 1 | Low porosity | CaCl₂ | 1.0% | 43.6 | 43.5 | 44.2 | 20.7 |
| 9 | 2 | High porosity | | 0.0% | 43.6 | 41.1 | 43.3 | 21.0 |
| 10 | 2 | High porosity | NaCl | 1.0% | 45.2 | 43.3 | 43.6 | 33.3 |
| 11 | 2 | High porosity | KCl | 1.0% | 43.3 | 42.9 | 45.0 | 34.6 |
| 12 | 2 | High porosity | NaOH | 1.0% | 43.8 | 38.9 | 43.3 | 34.5 |
| 13 | 2 | High porosity | Na₂CO₃ | 1.0% | 44.8 | 40.3 | 42.2 | 33.3 |
| 14 | 2 | High porosity | K₂CO₃ | 1.0% | 43.7 | 38.5 | 42.7 | |
| 15 | 2 | High porosity | MgCl₂ | 1.0% | 44.1 | 43.9 | 43.7 | 20.2 |
| 16 | 2 | High porosity | CaCl₂ | 1.0% | 44.1 | 43.5 | 45.8 | 19.8 |

TABLE 10

| | Calcium | | | Additive | | | Test D* |
|---|---|---|---|---|---|---|---|
| Sample | hydroxide | | | wt./sample | SS BET | Vp | (wt. % |
| No | (batch) No | Type | Additive | wt. | (m²/g) | (cm³/g) | CO₂) |
| 17 | 3 | Low porosity | | 0.0% | 16.126 | 0.1 | 12.28 |
| 18 | 3 | Low porosity | NaCl | 5.0% | 11.9 | 0.087 | 40.79 |
| 19 | 3 | Low porosity | KCl | 5.0% | 11.501 | 0.101 | 32.87 |
| 20 | 3 | Low porosity | NaOH | 5.0% | 6.066 | 0.027 | 27.06 |
| 21 | 3 | Low porosity | Na₂CO₃ | 5.0% | 11.283 | 0.064 | 32.87 |
| 22 | 3 | Low porosity | K₂CO₃ | 5.0% | 10.916 | 0.089 | 27.83 |
| 23 | 4 | High porosity | | 0.0% | 36.346 | 0.178 | 14.71 |
| 24 | 4 | High porosity | NaCl | 5.0% | 23.205 | 0.14 | 35.60 |
| 25 | 4 | High porosity | KCl | 5.0% | 22.421 | 0.138 | 35.15 |
| 26 | 4 | High porosity | NaOH | 5.0% | | 0.09 | 21.05 |
| 27 | 4 | High porosity | Na₂CO₃ | 5.0% | 21.892 | 0.132 | 27.31 |
| 28 | 4 | High porosity | K₂CO₃ | 5.0% | 23.677 | 0.138 | 24.46 |

TABLE 11

| | Calcium | | | Additive | | | |
|---|---|---|---|---|---|---|---|
| Sample | hydroxide | | | wt./sample | SS BET | Vp | Test D |
| No | (batch) No | Type | Additive | wt. | (m²/g) | (cm³/g) | (wt % CO₂) |
| 29 | 5 | Low porosity | | 0.0% | 15.228 | 0.1 | 13.6 |
| 30 | 5 | Low porosity | NaCl | 0.25% | 14.232 | 0.102 | 25.6 |
| 31 | 5 | Low porosity | NaCl | 0.5% | 14.037 | 0.096 | 32.4 |
| 32 | 5 | Low porosity | NaCl | 1.0% | 13.238 | 0.107 | 39.0 |
| 33 | 5 | Low porosity | NaCl | 2.0% | 13.57 | 0.096 | 39.6 |
| 34 | 5 | Low porosity | NaCl | 4.0% | 12.425 | 0.111 | 38.8 |
| 35 | 5 | Low porosity | NaCl | 6.0% | 12.585 | 0.095 | 39.3 |
| 36 | 6 | High porosity | | 0.0% | 35.21 | 0.16 | 15.43 |
| 37 | 6 | High porosity | NaCl | 0.25% | 29.33 | 0.15 | 19.07 |
| 38 | 6 | High porosity | NaCl | 0.5% | 29.57 | 0.15 | 22.44 |
| 39 | 6 | High porosity | NaCl | 1.0% | 29.05 | 0.15 | 30.85 |
| 40 | 6 | High porosity | NaCl | 2.0% | 27.90 | 0.15 | 37.45 |
| 41 | 6 | High porosity | NaCl | 4.0% | 24.15 | 0.14 | 37.39 |
| 42 | 6 | High porosity | NaCl | 6.0% | 24.01 | 0.14 | 36.82 |

The CO₂ fraction (wt. %) represents the amount of CO₂ chemically bound to the solid at the end of the experiment and is therefore proportional to the conversion of the calcium hydroxide into carbonate.

The CaCO₃ content (wt %) can be determined from the CO₂ content (wt. %) with the following formula (1) based on the atomic masses:

$${CaCO}_{3} ( wt . \% ) = 100 / 44 \cdot {CO}_{2} ( wt . \% )$$

The molar conversion of Ca(OH)₂ into CaCO₃ is calculated with the following formula (2)

$$X ( Molar conversion of {Ca ( OH )}_{2} into {CaCO}_{3} ) = \frac{( \frac{{CaCO}_{3} ( wt \% )}{100} )}{( \frac{{CaCO}_{3} ( wt \% )}{100} ) + ( \frac{100 \% - {CaCO}_{3} ( wt \% )}{74} )}$$

where it is assumed that the composition consists in two compounds CaCO₃ and Ca(OH)₂. The Ca(OH)₂ content is directly derivable from the CaCO₃ content, as follows Ca(OH)₂ (wt. %)=100%−CaCO₃ (wt. %). TABLE 12 below shows the correspondence between the CO₂ content and the CaCO₃ content or the molar conversion of Ca(OH)₂ into CaCO₃ (also known as molar conversion of calcium hydroxide).

TABLE 12

| CO₂(%) by | CaCO₃ (%) | molar conversion of |
|---|---|---|
| weight | by weight | Ca(OH)₂ into CaCO₃ |
| 0% | 0.00% | 0% |
| 2% | 4.55% | 3% |
| 4% | 9.09% | 7% |
| 6% | 13.64% | 10% |
| 8% | 18.18% | 14% |
| 10% | 22.73% | 18% |
| 12% | 27.27% | 22% |
| 14% | 31.82% | 26% |
| 16% | 36.36% | 30% |
| 18% | 40.91% | 34% |
| 20% | 45.45% | 38% |
| 22% | 50.00% | 43% |
| 24% | 54.55% | 47% |
| 26% | 59.09% | 52% |
| 28% | 63.64% | 56% |
| 30% | 68.18% | 61% |
| 32% | 72.73% | 66% |
| 34% | 77.27% | 72% |
| 36% | 81.82% | 77% |
| 38% | 86.36% | 82% |
| 40% | 90.91% | 88% |
| 42% | 95.45% | 94% |
| 44% | 100.00% | 100% |

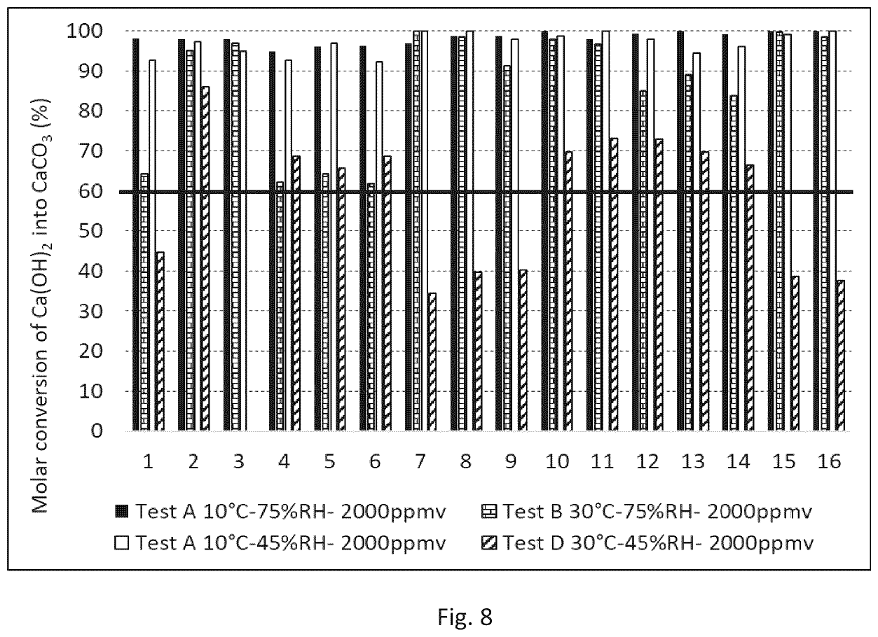

The results of the carbonation experiments are presented in FIGS. 8, 9A, 9B, 10A, 10B, 11A, 11B, 12A, 12B, 13A, 13B, 14A and 14B, and discussed in the subsequent paragraphs.

FIG. 8 discloses a comparison of molar conversions of calcium hydroxide compositions (samples 1-16) tested under four different simulated climatic conditions, namely Test A (CO₂: 2000 ppmv, 10° C. and 75% RH), Test B (CO₂: 2000 ppmv, 30° C. and 75% RH), Test C (CO₂: 2000 ppmv, 10° C. and 45% RH) and Test D (CO₂: 2000 ppmv, 30° C. and 45% RH). The molar conversions of Ca(OH)₂ into CaCO₃ are based on the CO₂ contents from table 12 that are recalculated using formulas (1) and (2). Table 12 indicates the correspondence between the molar conversions of Ca(OH)₂ into CaCO₃ and the CO₂(%) content for references values (e.g., 0%, 2%, 4% . . . , 44%).

Samples 2 to 6 and 10 to 14 are examples of the present disclosure. Samples 1, 7 to 9 and 15 to 16 are comparative examples. Samples 2 to 6 and 10 to 14 exhibit a molar conversion (of Ca(OH)₂ into CaCO₃) above about 60 mol % in the four tests A, B, C, D (when performed). This indicates that the hydroxide composition of samples 2 to 6 and 10 to 14 is more robust in terms of CO₂ capture compared to the other hydrated lime samples when subjected to different weather conditions. To achieve such a molar conversion of at least 60% corresponding to a CO₂ content of 29.45%, the composition has an additive selected from NaCl, KCl, NaOH, Na₂CO₃, K₂CO₃. It is observed that for Tests A (CO₂: 2000 ppmv, 10° C. and 75% RH) and C (CO₂: 2000 ppmv, 10° C. and 45% RH), all sorbents tested, even the comparative examples achieve a high CO₂ capture efficiency with a conversion ratio above 95%. It is also observed that low temperatures favor carbonation and the selection of a calcium hydroxide with a high porosity brings a marginal advantage. However, under elevated temperatures, the CO₂ capture levels drop, especially with a low humidity level. For instance, Test D (CO₂: 2000 ppmv, 30° C. and 45% RH) leads to the lowest CO₂ capture levels. Indeed, it is expected that in a dry environment, such as desertic conditions, the carbonation reaction is slowed down in absence of water.

The results in FIG. 8 also show that compositions with the calcium hydroxide No2 with a high porosity generally provide slightly better results than the compositions with the calcium hydroxide No1 with a low porosity under Test B (CO₂: 2000 ppmv, 30° C. and 75% RH). This gain becomes marginal with certain additives such as NaCl and KCl.

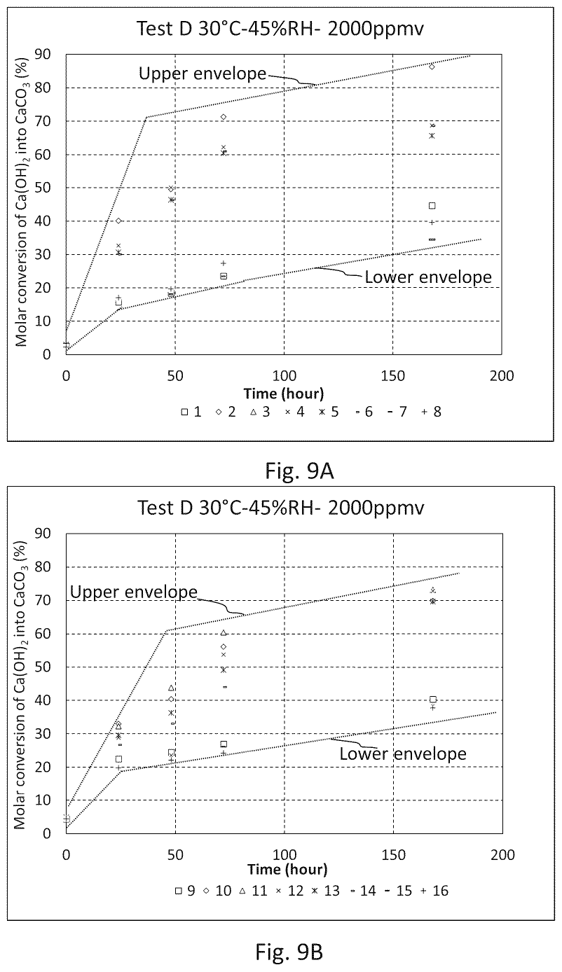

FIG. 9A illustrates CO₂ capture measurements over time obtained with different sorbents with a low porosity under Test D conditions (CO₂: 2000 ppmv, 30° C. and 45% RH). These sorbents comprise the calcium hydroxide No1 with low porosity and an additive selected from NaCl, KCl, NaOH, NaOH₂, K₂CO₃. The results show that a suitable ionic additive such as NaCl permits to boost CO₂ capture in a dry and hot environment. In FIG. 9A, an upper envelope curve indicating a upper boundary for the cluster of measurement points and a lower envelope curve indicating a lower boundary for the cluster of the measurement points, are overlayed to illustrate the dispersion of the measurement points (upper and lower envelope curves are also adapted to the correspond measurement points of the other figures and overlayed on them).

Likewise, FIG. 9B illustrates CO₂ capture measurements over time obtained with different sorbents with a high porosity under the Test D conditions (CO₂: 2000 ppmv, 30° C. and 45% RH). These sorbents comprise the calcium hydroxide No2 with high porosity and an additive selected from NaCl, KCl, NaOH, Na₂CO₃, K₂CO₃. The results show that a suitable ionic additive such as NaCl permits to improve the capture in a dry and hot environment.

A comparison between FIGS. 9A and 9B shows that the fineness (i.e. specific surface) of the pore microstructure of the calcium hydroxide influences the CO₂ capture efficiency, as the spread among the curves is reduced with sorbent with high porosity (specific surface) compared to sorbent with low specific surface. The selection of a suitable ionic additive allows compensating a lower CO₂ absorption capacity of the low porosity sorbent, especially in the transient phase. The selection of NaCl as an ionic additive enhances CO₂ capture efficiency more than the other ionic additives tested.

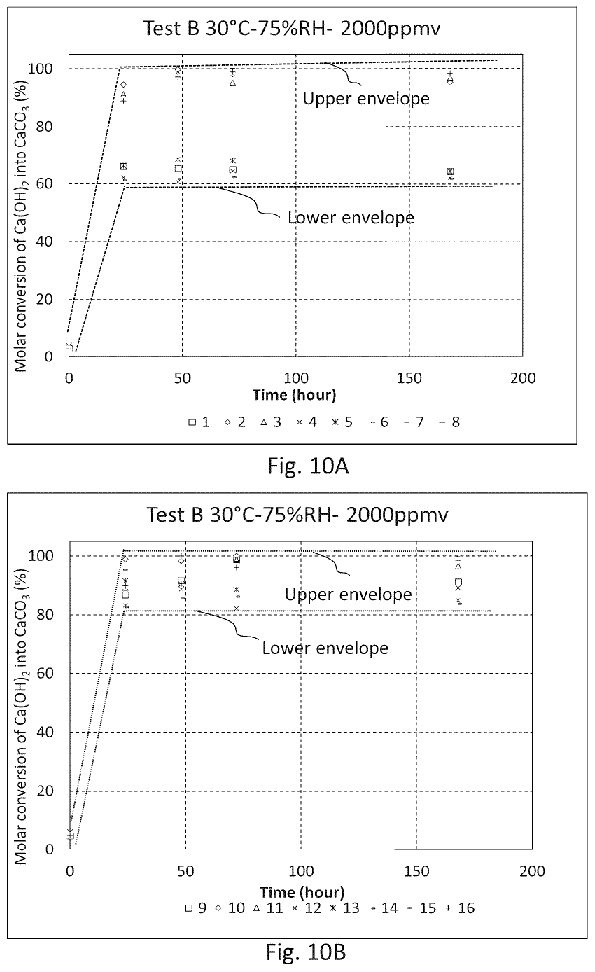

FIG. 10A illustrates CO₂ capture measurements over time obtained with different sorbents with a low porosity under Test B conditions (CO₂: 2000 ppmv, 30° C. and 75% RH). These sorbents comprise the calcium hydroxide No1 with the low porosity and an ionic additive selected from NaCl, KCl, NaOH, Na₂CO₃, K₂CO₃. The results show that a suitable ionic additive permits to boost the CO₂ capture of a low porosity sorbent (e.g. low specific surface), up to almost a full conversion in a hot and humid environment, typically encountered in tropical regions.

Similarly, FIG. 10B illustrates CO₂ capture measurements over time obtained with different sorbents with a high porosity under the Test B conditions (CO₂: 2000 ppmv, 30° C. and 75% RH). These sorbents comprise the calcium hydroxide No2 with high porosity and an ionic additive selected from NaCl, KCl, NaOH, Na₂CO₃, K₂CO₃. The results show that a suitable ionic additive also permits to boost the CO₂ capture of a high porosity sorbent (e.g. high specific surface) up to almost a full conversion in a hot and humid environment.

A comparison between FIGS. 10A and 10B shows that the specific surface of the calcium hydroxide source influences the CO₂ capture level, as the spread among the curves is reduced with a higher specific surface. However these results do also show that the selection of the right additive can offset a low porosity calcium hydroxide source in a hot and humid environment.

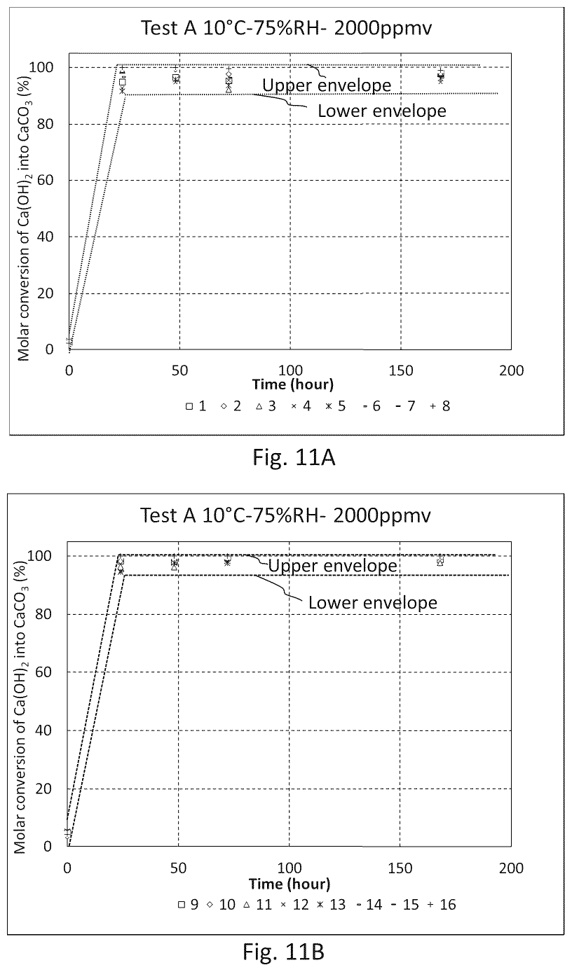

FIG. 11A illustrates CO₂ capture measurements over time obtained with different sorbents with a low porosity under Test A conditions (CO₂: 2000 ppmv, 10° C. and 75% RH). These sorbents comprise the calcium hydroxide No1 with the lower porosity and an ionic additive selected from NaCl, KCl, NaOH, Na₂CO₃, K₂CO₃. The results show that a sorbent with low porosity and no ionic additives performs well in CO₂ capture in cold, humid environments typically encountered in temperate climates. The selection of an additive does not influence significantly (increase or decrease) the CO₂ capture performance, in cold and humid environments. This is not surprising, as the full conversion capacity of the sorbent is nearly achieved without the ionic additive, and the additive is not strictly necessary under these weather conditions. Nevertheless, it is proven that the ionic additive, which is beneficial in hot and dry conditions, does not deteriorate the CO₂ capture potential of a low porosity sorbent in cold and humid conditions.

Likewise, FIG. 11B illustrates CO₂ capture measurements over time obtained with different sorbents with a high porosity under Test A conditions (CO₂: 2000 ppmv, 10° C. and 75% RH). These sorbents comprise the calcium hydroxide No2 with the high porosity and an ionic additive selected from NaCl, KCl, NaOH, Na₂CO₃, K₂CO₃. The results show that a sorbent with high porosity and no ionic additives performs well in CO₂ capture in cold, humid environments typically encountered in temperate climates. The results are comparable to those of the low-porosity sorbent in FIG. 11A, showing that porosity does not play a significant role under these cold and humid conditions. The selection of an additive does not influence significantly (increase or decrease) the CO₂ capture performance, in cold and humid environments. This is not surprising, as the full conversion capacity of the sorbent is nearly achieved without the ionic additive, and the additive is not strictly necessary under these weather conditions. Nevertheless, it is proven that the ionic additive, which is beneficial in hot and dry conditions, does not deteriorate the CO₂ capture potential of a high porosity sorbent in cold and humid conditions.

A comparison between FIGS. 11A and 11B shows that the CO₂ capture is high by default and neither the calcium hydroxide type (low vs. high porosity) nor the selected ionic additive influences significantly the CO₂ capture level, in a cold and humid environment.

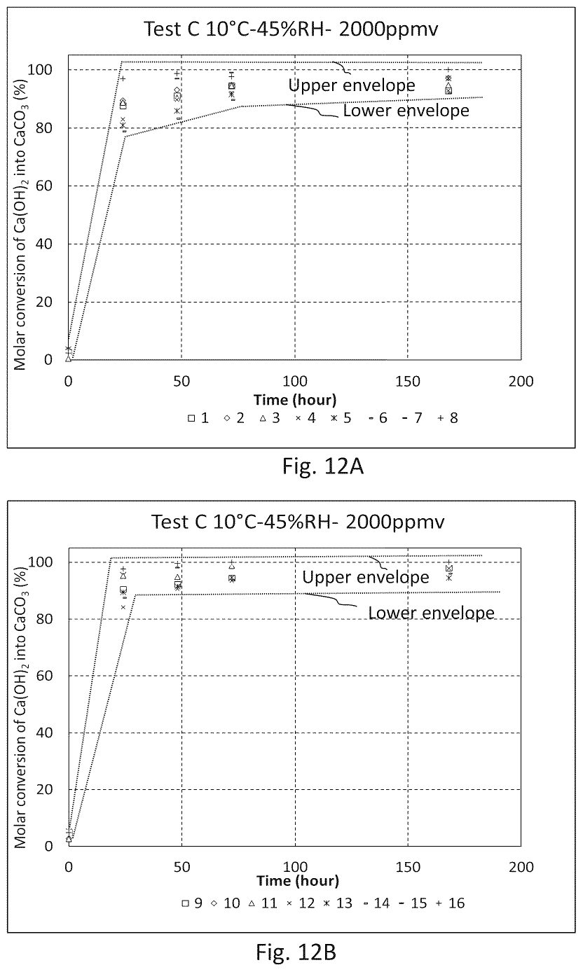

FIG. 12A illustrates CO₂ capture measurements over time obtained with different sorbents with a low porosity under Test C conditions (CO₂: 2000 ppmv, 10° C. and 45% RH). These sorbents comprise the calcium hydroxide No1 with the low porosity and an ionic additive selected from NaCl, KCl, NaOH, Na₂CO₃, K₂CO₃. The results show that the selection of the ionic additive does not influence significantly the CO₂ capture, in cold and dry environments.

Likewise, FIG. 12B illustrates CO₂ capture measurements over time obtained with different sorbents with a high porosity under the Test C conditions (CO₂: 2000 ppmv, 10° C. and 45% RH). These sorbents comprise the calcium hydroxide No2 with the high porosity and an ionic additive selected from NaCl, KCl, NaOH, Na₂CO₃, K₂CO₃. The results show that the selection of the ionic additive does not influence significantly in a cold and dry environments.

A comparison between FIGS. 12A and 12B shows that the CO₂ capture is high by default and neither the calcium hydroxide type (low vs. high porosity) nor the selected ionic additive influences significantly the CO₂ capture level in a cold and dry environment. The results show that a sorbent with high or low porosity and no ionic additives performs well in CO₂ capture in cold and dry environments. The selection of an additive does not influence significantly (increase or decrease) the CO₂ capture performance, in cold and dry environments. This is not surprising, as the full conversion capacity of the sorbent is nearly achieved without the ionic additive, and the additive is not strictly necessary under these conditions. Nevertheless, it is proven that the ionic additive, which is beneficial in hot and dry conditions, does not deteriorate the CO₂ capture potential of a high or low porosity sorbent in cold and dry conditions.

To conclude on the results of FIGS. 8, 9A, 9B, 10A, 10B, 11A, 11B, 12A and 12B, the introduction in sorbent of an additive based on an ionic compound according to the present disclosure such as NaOH, KOH, NaCl, KCl, Na₂CO₃ and K₂CO₃, improves the robustness of the sorbent in terms of adaptability to climate variations, especially for dry and hot climate. It has been discovered that the presence of an additive based on an ionic compound at least partially offsets the disadvantage of a less refined hydroxide microstructure (with reduced porosity) in terms of CO₂ capture robustness. The production of hydrated lime with high porosity is more complex and costly compared to standard hydrated lime with low porosity. Thanks to the measures of the present disclosure, it is possible to manufacture a sorbent using low porosity hydrated lime supplemented with a low-cost additive based on an ionic compound.

The influence of the concentration of the ionic additive is investigated in the weathering chamber No2 (WC2) in critical conditions, namely under high temperature and low humidity, as defined under the test D* (CO₂: 420 ppmv, 30° C. and 45% RH). A higher concentration of additive, namely 5% on a weight basis, is therefore selected compared to 1% used in the previous examples. Test D* is based on Test D and has been modified to simulate dry and hot conditions under a natural CO₂ concentration (i.e. 420 ppmv) for the purpose of this analysis. The following samples 17 to 28 are tested under the conditions of the Test D* in the second weathering chamber WC2.

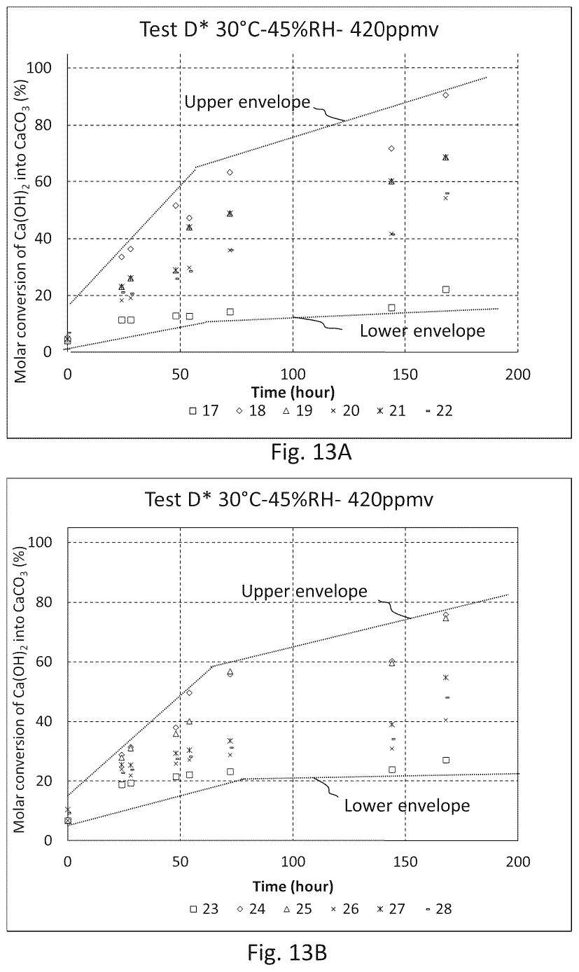

FIG. 13A illustrates CO₂ capture measurements over time obtained with different sorbents with a low porosity under the Test D* conditions (CO₂: 420 ppm, 30° C. and 45% RH). These sorbents comprise the calcium hydroxide No3 with the low porosity and an ionic additive selected from NaCl, KCl, NaOH, Na₂CO₃, K₂CO₃. As for the test D (see FIG. 9A), the results in FIG. 13A show that a suitable ionic additive such as NaCl permits to boost the capture even in a dry and hot environment.

The results of the samples 2-6 under Test D and samples 18-22 under Test D* are not directly comparable because the hydrated limes used are not exactly the same and the CO₂ concentration selected is not the same. In this context, it is observed that some of the maximal CO₂ conversions in FIG. 13A is improved, compared to those FIG. 9A, especially for NaCl.

Likewise FIG. 13B illustrate CO₂ capture measurements over time obtained with different sorbents with a high porosity under the Test D* conditions (CO₂: 420 ppm, 30° C. and 45% RH). These sorbents comprise the calcium hydroxide No4 with a high porosity and an ionic additive selected from NaCl, KCl, NaOH, Na₂CO₃, K₂CO₃. As, for the test D (see FIG. 9B), the results in FIG. 13B show that a suitable ionic additive such as NaCl permits to boost the capture even in a dry and hot environment.

A comparison between FIGS. 13A and 13B shows that the selection of an ionic additive influences significantly the CO₂ capture level, in a hot and dry environment. Samples 18 to 22 and 24 to 28 are also examples according to the present disclosure as they allow to reach a conversion of Ca(OH)₂ into CaCO₃ of at least 60%. Surprisingly, the sorbent based on low-porosity hydrated lime with NaCl No17 performs even better than the sorbent based on high-porosity hydrated lime with NaCl No24.

A detailed analysis of the influence of the concentration of the additive NaCl is investigated, as this ionic compound presents promising results. The analysis is performed in the weathering chamber No2 WC2 under test D* (CO₂: 420 ppm, 30° C. and 45% RH). The following samples 29 to 42 are tested under the conditions of the Test D* in the second weathering chamber WC2.

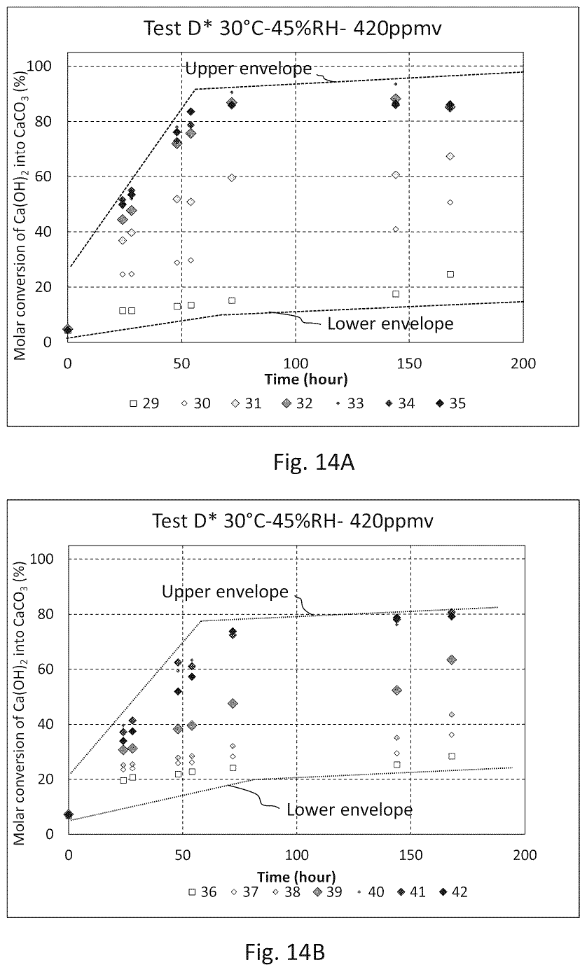

FIG. 14A illustrates CO₂ capture measurements over time obtained with different sorbents with a low porosity under Test D* conditions (CO₂: 420 ppm, 30° C. and 45% RH). These sorbents comprise the calcium hydroxide No5 with the low porosity and NaCl as additive with various weight fractions 0.25%, 0.5%, 1.0% 2.0%, 4.0% and 6.0%. The results in FIG. 14A show that with a weight fraction of around 2% the sorbent reaches its full potential.

FIG. 14B illustrates CO₂ capture measurements over time obtained with different sorbents with a high porosity under the Test D* conditions (CO₂: 420 ppm, 30° C. and 45% RH). These sorbents comprise the calcium hydroxide No6 with the higher porosity and NaCl as additive with various weight fraction 0.25%, 0.5%, 1.0% 2.0%, 4.0% and 6.0%. The results in FIG. 14B show, as for those in FIG. 14A, that with a weight fraction of around 2%, the sorbent reaches it full potential.

A comparison between FIGS. 14A and 14B shows that the concentration of an ionic additive influences CO₂ capture level, in a hot and dry environment. It is also noted that once a certain concentration is reached, the effect reaches a plateau. Samples 29 to 35 and 37 to 42 are also examples according to the present disclosure as they allow to reach a conversion of Ca(OH)₂ into CaCO₃ of at least 60%.

By “ionic compound” is meant a compound where chemical bonds are of ionic type, and which is able to decompose in its ionic components namely a negatively charged anion and positively charged cation.

By “the collection of the calcium carbonate-based composition” is meant “the step of collecting the calcium carbonate-based composition”.

Various aspects and embodiments of the present disclosure may be defined by one or more of the following clauses:

Clause A1. A process for direct capture of carbon dioxide in a CO₂-containing gas comprising the following steps:
optionally providing a calcium hydroxide-based composition;
contacting said composition with the CO₂-containing gas so as to capture CO₂ contained in said CO₂-containing gas by transforming at least some of the calcium hydroxide of said composition into calcium carbonate, forming a calcium carbonate-based composition;
optionally collecting the calcium carbonate-based composition;
optionally extracting at least some CO₂ from at least some of the collected calcium carbonate-based composition, preferably via calcination and/or electrolysis;
   wherein said calcium hydroxide-based composition comprises Ca(OH)₂ and an ionic compound with a content of 0.05% or higher than 0.05% by weight relative to the content of Ca(OH)₂, preferably higher than 0.25% by weight relative to the content of Ca(OH)₂, more preferably higher than 1.0% by weight relative to the content of Ca(OH)₂ but less than 10.0% by weight relative to the content of Ca(OH)₂, preferably less than 7.0% by weight relative to the content of Ca(OH)₂, more preferably less than 5% by weight relative to the content of Ca(OH)₂, in particular less than 2.0% by weight relative to the content of Ca(OH)₂, said ionic compound comprising an alkali and/or alkali earth metal cation and optionally said ionic compound being different from any element of the group consisting of Ca(OH)₂, CaCO₃, Mg(OH)₂ and MgCO₃, preferably said ionic compound comprising at least one of a hydroxide, halogen and/or carbonate anion;
   wherein the CO₂-containing gas is either air, flue gas or a mixture of them;
   optionally the calcium hydroxide-based composition having a weight fraction of Ca(OH)₂ of at least 80%, preferably at least 90% on a dry basis; optionally the ionic compound and/or the Ca(OH)₂ of the calcium hydroxide-based composition being homogeneously distributed in said composition.

Clause A2. The process according to Clause A1, wherein the ionic compound consists in at least one element selected from the group consisting of NaOH, KOH, NaCl, KCl, Na₂CO₃ and K₂CO₃.

Clause A3. The process according to any of Clauses A1 to A2, wherein the collection of the calcium carbonate-based composition takes place when said composition reaches a CO₂ content of at least 31%, preferably at least 33%, more preferably at least 37%, in particular at least 40% by weight on a dry basis and/or wherein in the step of contacting said composition with the CO₂-containing gas, the calcium hydroxide-based composition is exposed to the CO₂-containing gas having:
temperature(s) lower than 50° C. or equal to 50° C., preferably lower than 39° C. or preferably equal to 39° C. and optionally the temperature(s) being greater than 0° C., preferably greater than 15° C., and/or
relative humidity levels falling in the range from 10% to 95%, preferably in the range from 10% to 80%, more preferably in the range from 30% to 70%, in particular in the range from 35% to 60%.

Clause A4. The process according to any of Clauses A1 to A3, wherein the step of providing the calcium hydroxide-based composition comprises providing a malleable or flowable composition containing Ca(OH)₂ and the ionic compound, said (malleable or flowable) composition having, preferably before the step of contacting the calcium hydroxide-based composition with the CO₂-containing gas, a water content above 35% by weight of said composition, and optionally at most 85% by weight of said composition, such as a putty lime or a milk of lime.

Clause A5. The process according to Clause A4, further comprising
a) mixing a calcium hydroxide-based powder composition with the ionic compound, water and optionally a first additive or
b) slaking quicklime, possibly partly hydrated, in presence of the ionic compound and optionally in presence of a second additive,
   in order to obtain the malleable or flowable composition containing Ca(OH)₂ and the ionic compound, wherein the ionic compound is introduced during at least one of the mixing of step a) and/or slaking of step b).

Clause A6. The process according to any of Clauses A1 to A3, wherein the supply of the calcium hydroxide-based composition comprises the supply of shaped bodies (4) containing Ca(OH)₂ and the ionic compound or the step of providing of the calcium hydroxide-based composition comprises providing shaped bodies (4) containing Ca(OH)₂ and the ionic compound, preferably said shaped bodies (4) being in the form of pellets, granules, extrudates, 3D printings or compacts such as tablets or briquettes, preferably said shaped bodies (4) having at least one dimension greater than 3 mm.

Clause A7. The process according to Clause A6, further comprising, preferably before the step of providing the calcium hydroxide-based composition, shaping a malleable or flowable composition containing Ca(OH)₂ and the ionic compound, said composition having a water content above 35% by weight of said (malleable or flowable) composition, and optionally at most 85% by weight of said composition, such as a putty lime or a milk of lime, into the shaped bodies (4), in particular 3D printings or extrudates, preferably said malleable or flowable composition being obtained by mixing (step a) a calcium hydroxide-based powder composition with water, and optionally a first additive or slaking quicklime (step b), possibly partly hydrated, optionally in presence of a second additive, optionally forming ridges on the shaped bodies (4), notably curing said shaped bodies (4) with CO₂, preferably said step of curing taking place before the step of contacting the calcium hydroxide-based composition with the CO₂-containing gas, wherein the ionic compound is introduced during at least one of said mixing (step a) and/or said slaking (step b).

Clause A8. The process according to Clause A7, prior to the shaping of the shaped bodies (4), mixing the malleable or flowable composition with at least one element selected from the group comprising structural elements, such as woven or non-woven fibers, at least one additive, water, or any combination thereof, preferably the at least one additive being selected from the group comprising shaping additive, pore-forming agent, compressive strength enhancer such as cementitious material, additives to increase particle size such as gypsum and air entraining agent.

Clause A9. The process according to Clause A6, further comprising shaping a powder composition containing Ca(OH)₂ and the ionic compound into the shaped bodies (4), in particular pellets, granules, extrudates, 3D printings or compacts such as tablets or briquettes, preferably forming ridges on the shaped bodies (4), notably curing said shaped bodies (4) with CO₂, preferably said step of curing taking place before the step of contacting the calcium hydroxide-based composition with the CO₂-containing gas.

Clause A10. The process according to Clause A9, further comprising mixing a calcium hydroxide-based powder composition with the ionic compound and at least one element selected from the group comprising structural elements such as woven or non-woven fibers, at least one additive, water, or any combination thereof, thereby forming the powder composition containing Ca(OH)₂ and the ionic compound, preferably the at least one additive being selected from the group comprising shaping additive, pore-forming agent, compressive strength enhancer such as cementitious material, additives to increase particle size such as gypsum and air entraining agent.

Clause A11. The process according to any of Clauses A1 to A3, wherein the supply of the calcium hydroxide-based composition comprises the supply of a powder composition containing Ca(OH)₂ and the ionic compound or the step of providing of the calcium hydroxide-based composition comprises providing a powder composition containing Ca(OH)₂ and the ionic compound, said composition having a water content lower than or equal to 35% by weight of said composition, preferably at most 20% by weight, more preferably at most 15% by weight of said composition, and optionally at least 5% by weight, preferably at least 10% by weight of said composition, preferably the powder composition containing Ca(OH)₂ and the ionic compound being obtained by mixing a calcium hydroxide-based powder composition with the ionic compound.

Clause A12. The process according to any of Clauses A6 to A10, further comprising
providing a support (11, 12, 13, 14, 30) for the calcium hydroxide-based composition, said support being stationary or in motion relative to a reference frame, and
contacting the calcium hydroxide-based composition with the CO₂-containing gas in particular in a packed bed such as a fixed bed or a moving bed or in a fluidized bed such as a bubbling bed, a spouted bed, a circulating fluidized bed or an entrained bed, in particular the support being selected from the group comprising trommel, plate, such as corrugated plate, bucket, pile, shelf (14), tray, filter media, cartridge, grate, tile, wall, brick, carbonated product, net, ground, basket (14) and gabion (12).

Clause A13. The process according to Clause A11, further comprising:
providing a support (11, 12, 13, 14, 30) for the calcium hydroxide-based composition, said support being stationary or in motion relative to a reference frame, and—applying, in particular spreading, said composition on the support to form a layer, in particular forming ridges on said layer, preferably said support being selected from the group comprising trommel, plate, such as corrugated plate, bucket, pile, shelf (14), tray, filter media (11), such as clothes or bags in a bag filter, cartridge, grate, tile, wall, brick, carbonated product ground and net, preferably further comprising flowing air through the filter media (11) comprising the calcium hydroxide-based composition.

Clause A14. The process according to Clause A4 or A5, further comprising
providing a support (11, 12, 13, 14, 30) for the calcium hydroxide-based composition, said support being stationary or in motion relative to a reference frame, and—applying, preferably spreading or coating, the calcium hydroxide-based composition on the support to form a layer, in particular forming ridges on said layer, in particular said support being selected from the group comprising plate, such as corrugated plate, bucket, pile, shelf (14), tray, filter media, such as clothes or bags in a bag filter, cartridge, grate, tile, wall, brick, bead (30) carbonated product, ground and net.

Clause A15. The process according to any of Clauses A1 to A14, wherein the step of contacting the calcium hydroxide-based composition with said the CO₂-containing gas further comprises comprising adjusting (20, 21, 26) at least one of:
a CO₂-containing gas flow rate,
a calcium hydroxide-based composition flow rate,
a calcium hydroxide-based composition residence time,
a calcium hydroxide-based composition inventory,
a CO₂-containing gas temperature,
a CO₂-containing gas relative humidity,
a CO₂-containing gas absolute humidity, and/or
a absolute water content inside the calcium hydroxide-based composition,
   with at least one control means for controlling the CO₂ capture in the CO₂-containing gas comprising at least one of:
one or more CO₂-containing gas flow control elements, such as valve, guiding blade, fan, or blower,
calcium hydroxide-based composition flow control elements
a humidifier,
cooler, and/or
heater,
   preferably further providing a CO₂-containing gas flow inlet arranged upstream from the calcium hydroxide-based composition and/or a CO₂-containing gas flow outlet arranged downstream from the calcium hydroxide-based composition, in particular the step of adjusting further comprising adjusting as a function of at least one of:
weather conditions, in particular an ambient CO₂-containing gas temperature and/or a CO₂-containing gas relative humidity as measured or estimated at the CO₂-containing gas flow inlet,
the CO₂ content in said composition at one or more locations, and/or
the difference in CO₂ concentration between the CO₂-containing gas flow inlet and outlet.

Clause A16. The process according to any of Clauses A1 to A15, further comprising conditioning the collected calcium carbonate-based composition prior to the step of extracting at least some CO₂ from at least some of the collected calcium carbonate-based composition, preferably the step of conditioning comprising at least one of drying, grinding, milling, classifying, dehydroxylating or purifying the collected calcium carbonate-based composition, or any combination thereof, in particular the step of purifying comprising separating at least some of the unreacted calcium hydroxide from the collected calcium carbonate-based composition, for instance via at least one of the following purification processes: air classification, leaching, pealing or floatation, or any combination thereof.

Clause A17. The process according to any of Clauses A5, A7-A11, optionally in combination with any of Clauses A12 to A16, wherein the calcium hydroxide-based powder composition has a specific surface BET lower than 20 m²/g, preferably lower than 15 m²/g, in particular lower than 10 m²/g and/or a porous volume lower than 0.12 cm³/g, in particular lower than 0.1 cm³/g, said partial pore volume being calculated according to the BJH method for a range of pores having a diameter between 20 and 1000 Å in accordance with standard DIN 66134 (February 1998 version).

Clause A18. The process according to any of Clauses A5, A7-A11, optionally in combination with any of Clauses A12 to A16, the calcium hydroxide-based powder composition has a specific surface BET equal or higher than 20 m²/g, preferably higher than 30 m²/g, in particular higher than 35 m²/g and/or a porous volume equal to or higher than 0.12 cm³/g, in particular higher than 0.16 cm³/g, in particular higher than 0.2 cm³/g, said partial pore volume being calculated according to the BJH method for a range of pores having a diameter between 20 and 1000 Å in accordance with standard DIN 66134 (February 1998 version).

Clause A19. The process according to any of Clauses A1 to A18, wherein a first phase is formed by Ca(OH)₂ of the calcium hydroxide-based composition and a second phase is formed by the ionic compound, wherein the first and second phases are intimately bound and/or homogeneously distributed in the core or throughout the volume of at least one, in particular each one, of the shaped bodies (4).

Clause A20. A calcium hydroxide-based composition comprising Ca(OH)₂ and an ionic compound with a content of 0.05% or higher than 0.05% by weight relative to the content of Ca(OH)₂, preferably higher than 0.25% by weight relative to the content of Ca(OH)₂, more preferably higher than 1% by weight relative to the content of Ca(OH)₂ but less than 10.0% by weight relative to the content of Ca(OH)₂, preferably less than 7% by weight relative to the content of Ca(OH)₂, more preferably less than 5% by weight relative to the content of Ca(OH)₂, in particular less than 2% by weight relative to the content of Ca(OH)₂, said ionic compound comprising an alkali and/or alkali earth metal cation and optionally said ionic compound being different from any element of the group consisting of Ca(OH)₂, CaCO₃, Mg(OH)₂ and MgCO₃, preferably said ionic compound comprising at least one of a hydroxide and/or carbonate anion; wherein said calcium hydroxide-based composition has a water content above 35% by weight of said composition, and optionally at most 85% by weight of said calcium hydroxide-based composition, optionally the Ca(OH)₂ of the calcium hydroxide-based composition and/or the ionic compound being homogeneously distributed in said composition.

Clause A21. A calcium hydroxide-based composition according to Clause A20, wherein the ionic compound consists in at least one element selected from the group consisting of NaOH, KOH, Na₂CO₃ and K₂CO₃.

Clause A22. A calcium hydroxide-based composition according to Clause A20 or A21, wherein the calcium hydroxide-based composition is a flowable or malleable composition.

Clause A23. A calcium hydroxide-based composition according to any of Clauses A20 to A22, wherein the calcium hydroxide-based composition is a milk of lime or putty lime.

Clause A24. The composition according to any of Clauses A20 to A23, having a weight fraction of Ca(OH)₂ of at least 80%, preferably at least 90% on a dry basis.

Clause A25. A process for direct capture of carbon dioxide in a CO₂-containing gas comprising the following steps:
Providing a calcium hydroxide-based composition according to any of Clauses A20 to A24;
contacting said composition with the CO₂-containing gas so as to capture CO₂ contained in said CO₂-containing gas by transforming at least some of the calcium hydroxide of said composition into calcium carbonate, forming a calcium carbonate-based composition;
collecting the calcium carbonate-based composition;
extracting at least some CO₂ from at least some of the collected calcium carbonate-based composition, preferably via calcination and/or electrolysis;
   wherein the CO₂-containing gas is either air, flue gas or a mixture of them.

Clause A26. The process according to Clause A25, further comprising:
providing a support (30) for the calcium hydroxide-based composition, said support being stationary or in motion relative to a reference frame and
applying, in particular spreading or coating, the calcium hydroxide-based composition on the support to form a layer, in particular forming ridges on said layer, preferably said support being selected from the group comprising plate, such as corrugated plate, bucket, pile, shelf, tray, filter media, such as clothes or bags in a bag filter, cartridge, grate, tile, wall, brick, bead (30), carbonated product, ground and net.

Clause A27. A process for shaping the calcium hydroxide-based composition according to any of Clauses A20 to A24 into shaped bodies (4), in particular 3D printings or extrudates, preferably said shaped bodies having at least one dimension greater than 3 mm, in particular further comprising forming ridges on the shaped bodies and/or curing said shaped bodies with CO₂, more preferably further comprising prior to the shaping, the step of mixing said calcium hydroxide-based composition, with at least one element selected from the group comprising structural elements, such as woven or non-woven fibers, at least one additive, water, or any combination thereof, preferably the at least one additive being selected from the group comprising shaping additive, pore-forming agent, compressive strength enhancer such as cementitious material, additives to increase particle size such as gypsum and air entraining agent.

Clause A28. A calcium hydroxide-based composition obtained by the process of Clause A27, wherein said composition is in the form of shaped bodies, wherein the shaped bodies are selected from the group comprising pellets, granules, extrudates or 3D printings or compacts such as tablets or briquettes, optionally having an apparent density lower than 1.4 g/cm³, preferably lower than 1.1 g/cm³ and optionally higher than 0.8 g/cm³; optionally the Ca(OH)₂ of the calcium hydroxide-based composition being homogeneously distributed in said composition; optionally the ionic compound being homogeneously distributed in the calcium hydroxide-based composition, optionally wherein a first phase is formed by Ca(OH)₂ of the calcium hydroxide-based composition and a second phase is formed by the ionic compound, the first and second phases being intimately bound and/or homogeneously distributed in the core or throughout the volume of at least one, in particular each one, of the shaped bodies (4).

Clause A29. A process for direct capture of carbon dioxide in a CO₂-containing gas comprising the following steps:
Providing a calcium hydroxide-based composition according to Clause A28;
contacting said composition with the CO₂-containing gas so as to capture CO₂ contained in said the CO₂-containing gas by transforming at least some of the calcium hydroxide of said composition into calcium carbonate, forming a calcium carbonate-based composition;
collecting the calcium carbonate-based composition;
extracting at least some CO₂ from at least some of the collected calcium carbonate-based composition, preferably via calcination and/or electrolysis.

Clause A30. The process according to Clause A29, further comprising
providing a support (11, 12, 13, 14) for the calcium hydroxide-based composition, said support being stationary or in motion relative to a reference frame, and
contacting the calcium hydroxide-based composition with the CO₂-containing gas preferably in a packed bed such as a fixed bed or a moving bed or in a fluidized bed such as a bubbling bed, a spouted bed, a circulating fluidized bed or an entrained bed, in particular the support being selected from the group comprising trommel, plate, such as corrugated plate, bucket, pile, shelf (13), tray, filter media, cartridge, grate, tile, wall, brick, carbonated product, net, ground, basket (14) and gabion (12).

Clause A31. The process according to any of Clauses A25 to A26 or A29 to A30, wherein the step of contacting the calcium hydroxide-based composition with the CO₂-containing gas further comprises comprising adjusting (20, 21, 26) at least one of:
a CO₂-containing gas flow rate,
a calcium hydroxide-based composition flow rate,
a calcium hydroxide-based composition residence time,
a calcium hydroxide-based composition inventory,
a CO₂-containing gas temperature,
a CO₂-containing gas relative humidity,
a CO₂-containing gas absolute humidity, and/or
a absolute water content inside the calcium hydroxide-based composition, with at least one control means for controlling the CO₂ capture in the CO₂-containing gas comprising at least one of:
one or more CO₂-containing gas flow control elements, such as valve, guiding blade, fan, or blower,
calcium hydroxide-based composition flow control elements
a humidifier,
cooler, and/or
heater,
   preferably further providing a CO₂-containing gas flow inlet arranged upstream from the calcium hydroxide-based composition and/or a CO₂-containing gas flow outlet arranged downstream from the calcium hydroxide-based composition, in particular the step of adjusting further comprising adjusting as a function of at least one of:
weather conditions, in particular an ambient CO₂-containing gas temperature and/or a CO₂-containing gas relative humidity as measured or estimated at the CO₂-containing gas flow inlet,
the CO₂ content in said composition at one or more locations, and/or
the difference in CO₂ concentration between the CO₂-containing gas flow inlet and outlet.

Clause A32. The process according to any of Clauses A25 to A26 or A29 to A31, wherein, in the step of contacting said composition with said the CO₂-containing gas, the calcium hydroxide-based composition is exposed to the CO₂-containing gas having:
temperature(s) lower than 50° C. or equal to 50° C., preferably lower than 39° C. or preferably equal to 39° C. and optionally the temperature(s) being greater than 0° C., preferably greater than 15° C., and/or
relative humidity levels falling in the range from 10% to 95%, preferably in the range from 10% to 80%, in particular in the range from 40% to 80%.

Clause A33. The process according to any of Clauses A25 to A26 or A29 to A32, further comprising conditioning the collected calcium carbonate-based composition prior to the step of extracting at least some CO₂ from at least some of the collected calcium carbonate-based composition, preferably the step of conditioning comprising at least one of drying, grinding, milling, classifying, dehydroxylating or purifying the collected calcium carbonate-based composition, or any combination thereof, in particular the step of purifying comprising separating at least some of the unreacted calcium hydroxide from the collected calcium carbonate-based composition, for instance via at least one of the following purification processes: air classification, leaching, pealing or floatation, or any combination thereof.

Clause A34. The process according to any of Clauses A25 to A26 or A29 to A33, wherein the collection of the calcium carbonate based composition takes place when said composition reaches a CO₂ content of at least 31%, preferably at least 33%, more preferably at least 37%, in particular at least 40% by weight on a dry basis.

Clause A35. A manufacturing process for preparing a calcium hydroxide-based composition preferably according to any of Clauses A20 to A24, comprising:
mixing a calcium hydroxide-based powder composition with a ionic compound, water and optionally a first additive or
slaking quicklime, possibly partly hydrated, in presence of the ionic compound and optionally in presence of a second additive,
   in order to obtain the calcium hydroxide-based composition.

Clause A36. The manufacturing process according to Clause A35, wherein the ionic compound consists in at least one element selected from the group consisting of NaOH, KCl, NaCl, Na₂CO₃ and K₂CO₃.

Clause A37. The manufacturing process according to Clause A35 or A36, wherein the calcium hydroxide-based powder composition has a specific surface BET lower than 20 m²/g, preferably lower than 15 m²/g, in particular lower than 10 m²/g and/or a porous volume lower than 0.12 cm³/g, in particular lower than 0.1 cm³/g, said partial pore volume being calculated according to the BJH method for a range of pores having a diameter between 20 and 1000 Å in accordance with standard DIN 66134 (February 1998 version).

Clause A38. The manufacturing process according to any of Clauses A35 to A36, wherein the calcium hydroxide-based powder composition has a specific surface BET equal or higher than 20 m²/g, preferably higher than 30 m²/g, in particular higher than 35 m²/g and/or a porous volume equal to or higher than 0.12 cm³/g, in particular higher than 0.16 cm³/g, in particular higher than 0.2 cm³/g, said partial pore volume being calculated according to the BJH method for a range of pores having a diameter between 20 and 1000 Å in accordance with standard DIN 66134 (February 1998 version).

Clause A39. A process for direct capture of carbon dioxide in air comprising the following steps:
providing a calcium hydroxide-based composition;
contacting said composition with air so as to capture CO₂ contained in said air by transforming at least some of the calcium hydroxide of said composition into calcium carbonate, forming a calcium carbonate-based composition;
collecting the calcium carbonate-based composition;
extracting at least some CO₂ from at least some of the collected calcium carbonate-based composition, preferably via calcination and/or electrolysis;
   wherein said calcium hydroxide-based composition comprises Ca(OH)₂, the calcium hydroxide-based composition has preferably a weight fraction of Ca(OH)₂ of at least 80%, preferably at least 90% on a dry basis.

Clause B1. A process for direct capture of carbon dioxide in air comprising the following steps:
providing a calcium hydroxide-based composition;
contacting said composition with air so as to capture CO₂ contained in said air by transforming at least some of the calcium hydroxide of said composition into calcium carbonate, forming a calcium carbonate-based composition;
collecting the calcium carbonate-based composition;
extracting at least some CO₂ from at least some of the collected calcium carbonate-based composition, preferably via calcination and/or electrolysis;
   wherein said calcium hydroxide-based composition comprises Ca(OH)₂ and an ionic compound with a content of 0.05% or higher than 0.05% by weight relative to the content of Ca(OH)₂, preferably higher than 0.25% by weight relative to the content of Ca(OH)₂, more preferably higher than 1.0% by weight relative to the content of Ca(OH)₂ but less than 10.0% by weight relative to the content of Ca(OH)₂, preferably less than 7.0% by weight relative to the content of Ca(OH)₂, more preferably less than 5% by weight relative to the content of Ca(OH)₂, in particular less than 2.0% by weight relative to the content of Ca(OH)₂, said ionic compound comprising an alkali metal cation, preferably said ionic compound comprising at least one of a hydroxide, halogen and/or carbonate anion, wherein the calcium hydroxide-based composition has a weight fraction of Ca(OH)₂ of at least 80%, preferably at least 90% on a dry basis.

Clause B2. The process according to Clause B1, wherein the ionic compound consists in at least one element selected from the group consisting of NaOH, KOH, NaCl, KCl, Na₂CO₃ and K₂CO₃.

Clause B3. The process according to any of Clauses B1 to B2, wherein the Ca(OH)₂ of the calcium hydroxide-based composition and/or the ionic compound is homogeneously distributed in said composition.

Clause B4. The process according to any of Clauses B1 to B3, wherein in the step of contacting said composition with air, the calcium hydroxide-based composition is exposed to air having temperatures lower than 39° C. or equal to 39° C. and optionally the temperatures being greater than 0° C., preferably greater than 15° C.

Clause B5. The process according to any of Clauses B1 to B4, wherein in the step of contacting said composition with air, the calcium hydroxide-based composition is exposed to air having relative humidity levels falling in the range from 10% to 95%, preferably in the range from 10% to 80%, more preferably in the range from 30% to 70%, in particular in the range from 35% to 60%.

Clause B6. The process according to any of Clauses B1 to B5, wherein the collection of the calcium carbonate-based composition takes place when said composition reaches a CO₂ content of at least 31%, preferably at least 33%, more preferably at least 37%, in particular at least 40% by weight on a dry basis.

Clause B7. The process according to any of Clauses B1 to B6, wherein the step of providing the calcium hydroxide-based composition comprises providing a malleable or flowable composition containing Ca(OH)₂ and the ionic compound, said composition having a water content above 35% by weight of said composition, and optionally at most 85% by weight of said composition, such as a putty lime or a milk of lime.

Clause B8. The process according to Clause B7, further comprising
a) mixing a calcium hydroxide-based powder composition with the ionic compound, water and optionally a first additive or
b) slaking quicklime, possibly partly hydrated, in presence of the ionic compound and optionally in presence of a second additive,
   in order to obtain the malleable or flowable composition containing Ca(OH)₂ and the ionic compound, wherein the ionic compound is introduced during at least one of the mixing of step a) and/or slaking of step b).

Clause B9. The process according to any of Clauses B1 to B6, wherein the supply of the calcium hydroxide-based composition comprises the supply of shaped bodies (4) containing Ca(OH)₂ and the ionic compound, preferably said shaped bodies (4) being in the form of pellets, granules, extrudates, 3D printings or compacts such as tablets or briquettes, preferably said shaped bodies (4) having at least one dimension greater than 3 mm.

Clause B10. The process according to Clause B9, further comprising shaping a malleable or flowable composition containing Ca(OH)₂ and the ionic compound, said composition having a water content above 35% by weight of said composition, and optionally at most 85% by weight of said composition, such as a putty lime or a milk of lime, into the shaped bodies (4), in particular 3D printings or extrudates, preferably said malleable or flowable composition being obtained by mixing (step a) a calcium hydroxide-based powder composition with water, and optionally a first additive or slaking quicklime (step b), possibly partly hydrated, optionally in presence of a second additive, optionally forming ridges on the shaped bodies (4), notably curing said shaped bodies (4) with CO₂, wherein the ionic compound is introduced during at least one of said mixing (step a) and/or said slaking (step b).

Clause B11. The process according to Clause B9, further comprising shaping a powder composition containing Ca(OH)₂ and the ionic compound into the shaped bodies (4), in particular pellets, granules, extrudates, 3D printings or compacts such as tablets or briquettes, preferably forming ridges on the shaped bodies (4), notably curing said shaped bodies (4) with CO₂.

Clause B12. The process according to Clause B11, further comprising mixing a calcium hydroxide-based powder composition with the ionic compound and optionally at least one element selected from the group comprising structural elements such as woven or non-woven fibers, at least one additive, water, or any combination thereof, thereby forming the powder composition containing Ca(OH)₂ and the ionic compound, preferably the at least one additive being selected from the group comprising shaping additive, pore-forming agent, compressive strength enhancer such as cementitious material, additives to increase particle size such as gypsum and air entraining agent.

Clause B13. The process according to any of Clauses B9 to B12, wherein a first phase is formed by Ca(OH)₂ of the calcium hydroxide-based composition and a second phase is formed by the ionic compound, wherein the first and second phases are intimately bound and homogeneously distributed in the core or throughout the volume of at least one, in particular each one, of the shaped bodies (4).

Clause B14. The process according to any of Clauses B1 to B6, wherein the supply of the calcium hydroxide-based composition comprises the supply of a powder composition containing Ca(OH)₂ and the ionic compound, said composition having a water content lower than or equal to 35% by weight of said composition, preferably at most 20% by weight, more preferably at most 15% by weight of said composition, and optionally at least 5% by weight, preferably at least 10% by weight of said composition, preferably the powder composition containing Ca(OH)₂ and the ionic compound being obtained by mixing a calcium hydroxide-based powder composition with the ionic compound.

Clause B15. The process according to any of Clauses B8, B10, B12 and B14, optionally in combination with Clause B13, wherein the calcium hydroxide-based powder composition has a specific surface BET lower than 20 m²/g, preferably lower than 15 m²/g, in particular lower than 10 m²/g and/or a porous volume lower than 0.12 cm³/g, in particular lower than 0.1 cm³/g, said partial pore volume being calculated according to the BJH method for a range of pores having a diameter between 20 and 1000 Å in accordance with standard DIN 66134 (February 1998 version).

Clause C1. A process for direct capture of carbon dioxide in air comprising the following steps:
providing a calcium hydroxide-based composition;
contacting said composition with air so as to capture CO₂ contained in said air by transforming at least some of the calcium hydroxide of said composition into calcium carbonate, forming a calcium carbonate-based composition;
collecting the calcium carbonate-based composition;
extracting at least some CO₂ from at least some of the collected calcium carbonate-based composition, preferably via calcination and/or electrolysis;
   wherein said calcium hydroxide-based composition comprises Ca(OH)₂ and an ionic compound with a content of 0.05% or higher than 0.05% by weight relative to the content of Ca(OH)₂, preferably higher than 0.25% by weight relative to the content of Ca(OH)₂, more preferably higher than 1.0% by weight relative to the content of Ca(OH)₂ but less than 10.0% by weight relative to the content of Ca(OH)₂, preferably less than 7.0% by weight relative to the content of Ca(OH)₂, more preferably less than 5% by weight relative to the content of Ca(OH)₂, in particular less than 2.0% by weight relative to the content of Ca(OH)₂, said ionic compound comprising an alkali metal cation, preferably said ionic compound comprising at least one of a hydroxide, halogen and/or carbonate anion, wherein the calcium hydroxide-based composition has a weight fraction of Ca(OH)₂ of at least 80%, preferably at least 90% on a dry basis.

Clause C2. The process according to Clause 1, wherein the ionic compound consists in at least one element selected from the group consisting of NaOH, KOH, NaCl, KCl, Na₂CO₃ and K₂CO₃.

Clause C3. The process according to any of Clauses C1 to C2, wherein the Ca(OH)₂ of the calcium hydroxide-based composition and/or the ionic compound is homogeneously distributed in said composition.

Clause C4. The process according to any of Clauses C1 to C3, wherein in the step of contacting said composition with air, the calcium hydroxide-based composition is exposed to air having temperatures lower than 39° C. or equal to 39° C. and optionally the temperatures being greater than 0° C., preferably greater than 15° C.

Clause C5. The process according to any of Clauses C1 to C4, wherein in the step of contacting said composition with air, the calcium hydroxide-based composition is exposed to air having relative humidity levels falling in the range from 10% to 95%, preferably in the range from 10% to 80%, more preferably in the range from 30% to 70%, in particular in the range from 35% to 60%.

Clause C6. The process according to any of Clauses C1 to C5, wherein the collection of the calcium carbonate-based composition takes place when said composition reaches a CO₂ content of at least 31%, preferably at least 33%, more preferably at least 37%, in particular at least 40% by weight on a dry basis.

Clause C7. The process according to any of Clauses C1 to C6, wherein the step of providing the calcium hydroxide-based composition comprises providing a malleable or flowable composition containing Ca(OH)₂ and the ionic compound, said composition having, preferably before the step of contacting the calcium hydroxide-based composition with air, a water content above 35% by weight of said composition, and optionally at most 85% by weight of said composition, such as a putty lime or a milk of lime.

Clause C8. The process according to Clause C7, further comprising
a) mixing a calcium hydroxide-based powder composition with the ionic compound, water and optionally a first additive or
b) slaking quicklime, possibly partly hydrated, in presence of the ionic compound and optionally in presence of a second additive,
   in order to obtain the malleable or flowable composition containing Ca(OH)₂ and the ionic compound, wherein the ionic compound is introduced during at least one of the mixing of step a) and/or slaking of step b).

Clause C9. The process according to any of Clauses C1 to C6, wherein the the step of providing the calcium hydroxide-based composition comprises providing shaped bodies (4) containing Ca(OH)₂ and the ionic compound, preferably said shaped bodies (4) being in the form of pellets, granules, extrudates, 3D printings or compacts such as tablets or briquettes, preferably said shaped bodies (4) having at least one dimension greater than 3 mm.

Clause C10. The process according to Clause C9, further comprising, preferably before the step of providing the calcium hydroxide-based composition, shaping a malleable or flowable composition containing Ca(OH)₂ and the ionic compound, said composition having a water content above 35% by weight of said composition, and optionally at most 85% by weight of said composition, such as a putty lime or a milk of lime, into the shaped bodies (4), in particular 3D printings or extrudates, preferably said malleable or flowable composition being obtained by mixing (step a) a calcium hydroxide-based powder composition with water, and optionally a first additive or slaking quicklime (step b), possibly partly hydrated, optionally in presence of a second additive, optionally forming ridges on the shaped bodies (4), notably curing said shaped bodies (4) with CO₂, said step of curing taking place before the step of contacting the calcium hydroxide-based composition with air, wherein the ionic compound is introduced during at least one of said mixing (step a) and/or said slaking (step b).

Clause C11. The process according to Clause C9, further comprising shaping a powder composition containing Ca(OH)₂ and the ionic compound into the shaped bodies (4), in particular pellets, granules, extrudates, 3D printings or compacts such as tablets or briquettes, preferably forming ridges on the shaped bodies (4), notably curing said shaped bodies (4) with CO₂, said step of curing taking place before the step of contacting the calcium hydroxide-based composition with air.

Clause C12. The process according to Clause C11, further comprising mixing a calcium hydroxide-based powder composition with the ionic compound and optionally at least one element selected from the group comprising structural elements such as woven or non-woven fibers, at least one additive, water, or any combination thereof, thereby forming the powder composition containing Ca(OH)₂ and the ionic compound, preferably the at least one additive being selected from the group comprising shaping additive, pore-forming agent, compressive strength enhancer such as cementitious material, additives to increase particle size such as gypsum and air entraining agent.

Clause C13. The process according to any of Clauses C9 to C12, wherein a first phase is formed by Ca(OH)₂ of the calcium hydroxide-based composition and a second phase is formed by the ionic compound, wherein the first and second phases are homogeneously distributed in the core or throughout the volume of at least one, in particular each one, of the shaped bodies (4).

Clause C14. The process according to any of Clauses C1 to C6, wherein the supply of the calcium hydroxide-based composition comprises the supply of a powder composition containing Ca(OH)₂ and the ionic compound, said composition having a water content lower than or equal to 35% by weight of said composition, preferably at most 20% by weight, more preferably at most 15% by weight of said composition, and optionally at least 5% by weight, preferably at least 10% by weight of said composition, preferably the powder composition containing Ca(OH)₂ and the ionic compound being obtained by mixing a calcium hydroxide-based powder composition with the ionic compound.

Clause C15. The process according to any of Clauses C8, C10, C12 and C14, optionally in combination with Clause C13, wherein the calcium hydroxide-based powder composition has a specific surface BET lower than 20 m²/g, preferably lower than 15 m²/g, in particular lower than 10 m²/g and/or a porous volume lower than 0.12 cm³/g, in particular lower than 0.1 cm³/g, said partial pore volume being calculated according to the BJH method for a range of pores having a diameter between 20 and 1000 Å in accordance with standard DIN 66134 (February 1998 version).

1. A process for direct capture of carbon dioxide in air, the process comprising:
providing a calcium hydroxide-based composition;
contacting said composition with air so as to capture CO₂ contained in said air by transforming at least some of the calcium hydroxide of said composition into calcium carbonate, forming a calcium carbonate-based composition;
collecting the calcium carbonate-based composition;
extracting at least some CO₂ from at least some of the collected calcium carbonate-based composition;
wherein said calcium hydroxide-based composition comprises Ca(OH)₂ and an ionic compound with a content of 0.05% or higher than 0.05% by weight relative to the content of Ca(OH)₂ but less than 10.0% by weight relative to the content of Ca(OH)₂, said ionic compound comprising an alkali metal cation, wherein the calcium hydroxide-based composition has a weight fraction of Ca(OH)₂ of at least 80% on a dry basis.

2. The process according to claim 1, wherein the ionic compound comprises at least one element selected from the group consisting of NaOH, KOH, NaCl, KCl, Na₂CO₃, and K₂CO₃.

3. The process according to claim 1, wherein the Ca(OH)₂ of the calcium hydroxide-based composition and/or the ionic compound is homogeneously distributed in said composition.

4. The process according to claim 1, wherein in the step of contacting said composition with air, the calcium hydroxide-based composition is exposed to air having temperatures lower than or equal to 39° C. or lower than or equal to 39° C. and greater than 0° C.

5. The process according to claim 1, wherein in the step of contacting said composition with air, the calcium hydroxide-based composition is exposed to air having relative humidity levels falling in a range from 10% to 95%.

6. The process according to claim 1, wherein the collection of the calcium carbonate-based composition takes place when said composition reaches a CO₂ content of at least 31% by weight on a dry basis.

7. The process according to claim 1, wherein the step of providing the calcium hydroxide-based composition comprises providing a malleable or flowable composition containing Ca(OH)₂ and the ionic compound, said malleable or flowable composition having a water content above 35% by weight of said composition or having a water content above 35% and at most 85% by weight of said composition.

8. The process according to claim 7, further comprising
c) mixing a calcium hydroxide-based powder composition with the ionic compound, water and optionally a first additive or
d) slaking quicklime or partly hydrated quicklime in presence of the ionic compound or in presence of the ionic compound and a second additive,
in order to obtain the malleable or flowable composition containing Ca(OH)₂ and the ionic compound, wherein the ionic compound is introduced during at least one of the mixing of step a) and/or slaking of step b).

9. The process according to claim 8, wherein the calcium hydroxide-based powder composition has a specific surface BET lower than 20 m²/g and/or a porous volume lower than 0.12 cm³/g, said partial pore volume being calculated according to the BJH method for a range of pores having a diameter between 20 and 1000 Å in accordance with standard DIN 66134 (February 1998 version).

10. The process according to claim 1, wherein the step of providing the calcium hydroxide-based composition comprises providing shaped bodies containing Ca(OH)₂ and the ionic compound.

11. The process according to claim 10, further comprising shaping the malleable or flowable composition containing Ca(OH)₂ and the ionic compound into the shaped bodies, said malleable or flowable composition being obtained by mixing (step a) a calcium hydroxide-based powder composition with water or with water and a first additive, or slaking (step b) quicklime or partly hydrated quicklime, wherein the ionic compound is introduced during at least one of said mixing (step a) and/or said slaking (step b).

12. The process according to claim 11, further comprising curing the shaped bodies with CO₂, said step of curing taking place before the step of contacting the calcium hydroxide-based composition with air.

13. The process according to claim 10, further comprising shaping a powder composition containing Ca(OH)₂ and the ionic compound into the shaped bodies.

14. The process according to claim 13, further comprising mixing a calcium hydroxide-based powder composition with the ionic compound or with the ionic compound and at least one element selected from the group comprising structural elements, at least one additive, water, or any combination thereof, thereby forming the powder composition containing Ca(OH)₂ and the ionic compound.

15. The process according to claim 10, wherein a first phase is formed by Ca(OH)₂ of the calcium hydroxide-based composition and a second phase is formed by the ionic compound, wherein the first and second phases are homogeneously distributed in the core or throughout the volume of at least one of the shaped bodies.

16. The process according to claim 10, wherein the shaped bodies are in the form of pellets, granules, extrudates, 3D printings, tablets, or briquettes.

17. The process according to claim 10, wherein the shaped bodies have at least one dimension greater than 3 mm.

18. The process according to claim 10, wherein the shaped bodies are in the form of pellets, granules, extrudates, 3D printings, tablets, or briquettes.

19. The process according to claim 10, wherein the shaped bodies have at least one dimension greater than 3 mm.

20. The process according to claim 1, wherein the supply of the calcium hydroxide-based composition comprises the supply of a powder composition containing Ca(OH)₂ and the ionic compound, said composition having a water content lower than or equal to 35% by weight of said composition or 5% to 35% by weight of said composition.
